(19) United States
(12) Patent Application Publication
(10) Pub. No.: US 2026/0101331 A1
(43) Pub. Date: Apr. 9, 2026

(54) ERROR-CORRECTION CODING METHODS FOR MIXED TRAFFIC IN WIRELESS COMMUNICATIONS, AND APPARATUSES, SYSTEMS, AND NON-TRANSITORY COMPUTER-READABLE STORAGE DEVICES EMPLOYING SAME

(71) Applicant: Huawei Technologies Co., Ltd., Shenzhen (CN)

(72) Inventors: Yu Cao, Ottawa (CA); Huazi Zhang, Hangzhou (CN); Jianglei Ma, Ottawa (CA); Van Hung Vu, Gatineau (CA)

(21) Appl. No.: 19/400,683

(22) Filed: Nov. 25, 2025

Related U.S. Application Data
(63) Continuation of application No. PCT/CN2024/093914, filed on May 17, 2024.
(60) Provisional application No. 63/504,668, filed on May 26, 2023.

(51) Int. Cl. H04W 72/1263; H04L 1/00; H04L 47/24

(52) U.S. Cl. CPC H04W 72/1263; H04L 1/0003; H04L 47/24

(57) ABSTRACT

A method has the step of: transmitting a downlink control information message for scheduling an uplink or downlink transmission of a plurality of data pieces of a plurality of traffic types in a single data block via a communication resource, the plurality of traffic types comprising a first traffic type for transmission via a first portion of the communication resource and a second traffic type for transmission via a second portion of the communication second resource.

### CROSS-REFERENCE TO RELATED APPLICATIONS

This application is a continuation of International Patent Application PCT/CN2024/093914, filed on May 17, 2024, which claims the benefit of U.S. Provisional Patent Application Ser. No. 63/504,668, filed May 26, 2023. The contents of each of the aforementioned applications are hereby incorporated by reference in their entirety.

### FIELD OF THE DISCLOSURE

The present disclosure relates generally to communication systems, apparatuses, methods, and non-transitory computer-readable storage devices, and in particular to error-correction coding methods for mixed traffic in wireless communications, and apparatuses, systems, and non-transitory computer-readable storage devices employing same.

### BACKGROUND

Wireless communication systems such as mobile communication systems are known. In future wireless communication systems such as the sixth generation (6G) mobile communication systems, resilience may be a fundamental feature. With the evolution of so-called “Industry 4.0” and many other technology visions, ultra-reliable and low latency wireless communications are a pivotal enabler for automated manufacturing on a massive scale.

Resilience may become a fundamental feature in future wireless communication systems such as 6G mobile communication systems. With the evolution of so-called “Industry 4.0” and many other technology visions, ultra-reliable and low latency wireless communications are a pivotal enabler for automated manufacturing on a massive scale.

Two trends are observed in the transition toward 6G. From the technological perspective, millimeter wave (mmWave) and massive multiple-input-multiple-output (MIMO) technologies will be more prevalent because they can significantly expand the current bandwidth resource. From the service perspective, a single device will need to support multiple services with different latency and reliability requirements. The two trends, together with a more stringent resilience requirement, provide an opportunity to re-design the physical layer of the wireless communication protocol stack.

A scenario emerges as multiple services converge into one physical-layer wireless link. The purpose of such a scenario is to deliver multiple quality-of-service (QoS) levels to multiple services within a single wireless link. Given the high carrier frequency and massive number of antennas in this scenario, beamforming can be performed more aggressively, enabling the convergence of multiple services in one wireless link. Meanwhile, these services may have very diverse key performance indicators (KPIs). For example, ultra-reliable low latency communications (URLLC), massive machine type communications (mMTC), enhanced mobile broadband (eMBB), terabit per second (Tbps) communications, and the like, may all be integrated in one link. This is challenging because different KPIs, for example for signal to noise ratio (SNR), fading, and/or the like, must be supported under the same wireless channel (such as having the same SNR, fading, and/or the like). To accommodate different kinds of data transfer services, multiple types of logical channels are defined in communication standards.

When a user equipment (UE) is scheduled for a transmission, the UE selects a logical channel based on its priority and other information. The UE maps the logical channel to a transport channel to be used for encoding. The encoding operation and physical layer transmission scheme is independent of the traffic type. Therefore, different traffic types are usually separately encoded (that is, the encoding procedure is performed without regard to the traffic type).

However, when the UE has multiple traffic types to transmit, it may not be efficient to separately encode the multiple traffic types. For example, separate encoding and transmission of more important data using a lower code rate is not efficient because it cannot benefit from the coding gain of a longer code when the more important data is relatively short. To achieve the same reliability, more coded bits are usually required. As such, spectral efficiency will be reduced and, moreover, extra signaling overhead will be required, for example, for resource allocation.

Therefore, there is a desire for error-correction coding methods for mixed traffic in wireless communications, and apparatuses, systems, and non-transitory computer-readable storage devices employing same.

### SUMMARY

Embodiments of this disclosure relate to systems, apparatuses, methods, and non-transitory computer-readable storage devices employing an error-correction coding method for mixed traffic (also called a “mixed-traffic coding method”) for wireless communications.

According to one aspect of this disclosure, there is provided a first method comprising: transmitting a downlink control information message for scheduling an uplink or downlink transmission of a plurality of data pieces of a plurality of traffic types in a single data block via a communication resource, the plurality of traffic types comprising a first traffic type for transmission via a first portion of the communication resource and a second traffic type for transmission via a second portion of the communication second resource.

In some embodiments, the first method further comprises: receiving or transmitting the plurality of data pieces in accordance with said scheduling specified in the downlink control information message.

In some embodiments, the plurality of data pieces of the plurality of traffic types comprises data generated by different applications that needs to be transmitted and/or received in different ways, data with different QoS requirements, data with different data rate requirements, data with different reliability requirements, data with different latency requirements, data with different priority requirements, and/or data to be transmitted in different logical channels.

In some embodiments, the plurality of traffic types comprises at least two types selected from ultra-reliable low latency communications, enhanced mobile broadband, massive machine type communications, and terabyte-per-second communications.

In some embodiments, the downlink control information message comprises: a first indication for indicating the plurality of traffic types; a second indication for indicating an amount of the first portion of the communication resource used by the first traffic type; a third indication for indicating a modulation-and-coding scheme for each traffic type; or a combination thereof.

In some embodiments, the second indication is a first ratio of the amount of the first portion of the communication resource used by the first one of the plurality of traffic types over an amount of the communication resource.

In some embodiments, the first indication comprises a list having a plurality of items each corresponding to one of the plurality of traffic types; and each item comprises a traffic type of the plurality of traffic types, a priority, a quality-of-service value, a logical channel, or a logical channel group.

In some embodiments, each priority is represented by a priority index.

In some embodiments, each logical channel or logical channel group is represented by an identifier.

In some embodiments, the logical channel or logical channel group corresponding to each traffic type is selected from a plurality of logical channels or logical channel groups predefined or preconfigured available to the traffic type.

In some embodiments, the plurality of logical channels or logical channel groups available to each traffic type are preconfigured via a radio resource control message.

In some embodiments, the plurality of items are ordered in accordance with a predefined or preconfigured rule.

In some embodiments, the predefined or preconfigured rule is from lower priority to higher priority, from higher priority to lower priority, from lower quality-of-service value to higher quality-of-service value, or from higher quality-of-service value to lower quality-of-service value.

In some embodiments, the second indication comprises a number of symbols for the data piece of the first traffic type, or a ratio of an amount of physical resource blocks of the first portion of the communication resource over an amount of physical resource blocks of the communication resource.

In some embodiments, a joint coding method such as a mixed-traffic coding method is used for encoding at least a portion of the data piece of the first traffic type with the data piece of the second traffic type; and the downlink control information message further comprises a fourth indication for indicating an amount of the at least portion of the data piece of the first traffic type.

In some embodiments, the fourth indication is a second ratio of the at least portion of the data piece of the first traffic type over the data piece of the first traffic type.

In some embodiments, the downlink control information message further comprises: a fifth indication for indicating the use of the joint coding method.

In some embodiments, the fifth indication is a one-bit field.

In some embodiments, the modulation-and-coding scheme for each traffic type corresponds to a respective modulation-and-coding scheme table, or the modulation-and-coding schemes for the plurality of traffic types correspond to a same modulation-and-coding scheme table.

In some embodiments, the first method further comprises: receiving one or more scheduling requests requesting the uplink transmission of the plurality of data pieces; the downlink control information message is for scheduling the uplink transmission of the plurality of data pieces.

In some embodiments, a first one of the one or more scheduling requests comprises a request for two or more of the plurality of traffic types.

In some embodiments, the first scheduling request is associated with two or more logical channels each corresponding to a respective one of the two or more traffic types.

In some embodiments, the first scheduling request comprises two or more scheduling request identifiers each corresponding to a respective one of the two or more logical channels.

In some embodiments, each of the two or more scheduling request identifiers indicates a scheduling request configuration to which the respective logical channel is mapped and for which a scheduling request resource is used.

In some embodiments, the single data block is a single transport block.

According to one aspect of this disclosure, there is provided a second method comprising: transmitting one or more downlink control information messages for scheduling a plurality of uplink or downlink transmissions of a plurality of data piece of a plurality of traffic types, each uplink or downlink transmission being for transmission of a data piece of a respective traffic type, the plurality of traffic types comprising a first traffic type for transmission in a first data block via a first communication resource and a second traffic type in a second data block via a second communication resource; a joint coding method such as a mixed-traffic coding method is used for encoding the data piece of the traffic type into a first codeword for transmission via the first communication resource, and encoding at least a portion of the data piece of the first traffic type with the data piece of the second traffic type into a second codeword for transmission via the second communication resource.

In some embodiments, the second method further comprises: receiving or transmitting the plurality of data pieces in accordance with said scheduling specified in the downlink control information message.

In some embodiments, the plurality of data pieces of the plurality of traffic types comprises data generated by different applications that needs to be transmitted and/or received in different ways, data with different QoS requirements, data with different data rate requirements, data with different reliability requirements, data with different latency requirements, data with different priority requirements, and/or data to be transmitted in different logical channels.

In some embodiments, the plurality of traffic types comprises at least two types selected from ultra-reliable low latency communications, enhanced mobile broadband, massive machine type communications, and terabyte-per-second communications.

In some embodiments, the one or more downlink control information messages comprise a first downlink control information message for scheduling the uplink or downlink transmission of the data piece of the second traffic type; and the first downlink control information message comprises: a first indication for indicating the use of the joint coding method, a second indication for indicating the second traffic type, and a third indication for indicating the first data block.

In some embodiments, the first downlink control information message further comprises: a fourth indication for indicating an amount of the at least portion of the data piece of the first traffic type.

In some embodiments, the fourth indication is a first ratio of the at least portion of the data piece of the first traffic type over the data piece of the first traffic type.

In some embodiments, the first indication is a one-bit field.

In some embodiments, the third indication is a hybrid-automatic-repeat-request process number, a multiplexing index, a priority index, a service index, a traffic-type indication, or a logical channel index.

In some embodiments, the first downlink control information message further comprises: a fifth indication for indicating the second data block.

According to one aspect of this disclosure, there is provided a third method comprising: receiving a downlink control information message for scheduling an uplink or downlink transmission of a plurality of data pieces of a plurality of traffic types in a single data block via a communication resource, the plurality of traffic types comprising a first traffic type for transmission via a first portion of the communication resource and a second traffic type for transmission via a second portion of the communication second resource.

In some embodiments, the third method further comprises: receiving or transmitting the plurality of data pieces in accordance with said scheduling specified in the downlink control information message.

In some embodiments, the plurality of data pieces of the plurality of traffic types comprises data generated by different applications that needs to be transmitted and/or received in different ways, data with different QoS requirements, data with different data rate requirements, data with different reliability requirements, data with different latency requirements, data with different priority requirements, and/or data to be transmitted in different logical channels.

In some embodiments, the plurality of traffic types comprises at least two types selected from ultra-reliable low latency communications, enhanced mobile broadband, massive machine type communications, and terabyte-per-second communications.

In some embodiments, the downlink control information message comprises: a first indication for indicating the plurality of traffic types; a second indication for indicating an amount of the first portion of the communication resource used by the first traffic type; a third indication for indicating a modulation-and-coding scheme for each traffic type; or a combination thereof.

In some embodiments, the second indication is a first ratio of the amount of the first portion of the communication resource used by the first traffic type over an amount of the communication resource.

In some embodiments, the first indication comprises a list having a plurality of items each corresponding to one of the plurality of traffic types; and each item comprises a traffic type of the plurality of traffic types, a priority, a quality-of-service value, a logical channel, or a logical channel group.

In some embodiments, each priority is represented by a priority index.

In some embodiments, each logical channel or logical channel group is represented by an identifier.

In some embodiments, the logical channel or logical channel group corresponding to each traffic type is selected from a plurality of logical channels or logical channel groups predefined or preconfigured available to the traffic type.

In some embodiments, the plurality of logical channels or logical channel groups available to each traffic type are preconfigured via a radio resource control message.

In some embodiments, the plurality of items are ordered in accordance with a predefined or preconfigured rule.

In some embodiments, the predefined or preconfigured rule is from lower priority to higher priority, from higher priority to lower priority, from lower quality-of-service value to higher quality-of-service value, or from higher quality-of-service value to lower quality-of-service value.

In some embodiments, the second indication comprises a number of symbols for the data piece of the first traffic type, or a ratio of an amount of physical resource blocks of the first portion of the communication resource over an amount of physical resource blocks of the communication resource.

In some embodiments, a joint coding method such as a mixed-traffic coding method is used for encoding at least a portion of the data piece of the first traffic type with the data piece of the second traffic type; and the downlink control information message further comprises a fourth indication for indicating an amount of the at least portion of the data piece of the first traffic type.

In some embodiments, the fourth indication is a second ratio of the at least portion of the data piece of the first traffic type over the data piece of the first traffic type.

In some embodiments, the downlink control information message further comprises: a fifth indication for indicating the use of the joint coding method.

In some embodiments, the fifth indication is a one-bit field.

In some embodiments, the modulation-and-coding scheme for each traffic type corresponds to a respective modulation-and-coding scheme table, or the modulation-and-coding schemes for the plurality of traffic types correspond to a same modulation-and-coding scheme table.

In some embodiments, the third method further comprises: transmitting one or more scheduling requests requesting the uplink transmission of the plurality of data pieces; the downlink control information message is for scheduling the uplink transmission of the plurality of data pieces.

In some embodiments, a first one of the one or more scheduling requests comprises a request for two or more of the plurality of traffic types.

In some embodiments, the first scheduling request is associated with two or more logical channels each corresponding to a respective one of the two or more traffic types.

In some embodiments, the first scheduling request comprises two or more scheduling request identifiers each corresponding to a respective one of the two or more logical channels.

In some embodiments, each of the two or more scheduling request identifiers indicates a scheduling request configuration to which the respective logical channel is mapped and for which a scheduling request resource is used.

In some embodiments, the third method further comprises: determining a first payload size based on a size of a buffer for the first traffic type, a maximum value, or a smaller one of the buffer and the maximum value, the first payload size being a payload size of the data piece of the first traffic type; determining an amount of the first portion of the communication resource based on the first payload size, a modulation-and-coding scheme for the first traffic type; determining an amount of the second portion of the communication resource; determining a second payload size based on the amount of the second portion of the communication resource; and determining a payload size of the data piece of the second traffic type based on the second payload size.

In some embodiments, the predefined maximum value is determined based on a maximum amount of the communication resource available for being used as the first portion of the communication resource.

In some embodiments, the third method further comprises: determining an amount of the first portion of the communication resource; determining a first payload size based on the amount of the first portion of the communication resource, the first payload size being a payload size of the data piece of the first traffic type; determining an amount of the second portion of the communication resource; determining a second payload size based on the amount of the second portion of the communication resource; and determining a payload size of the data piece of the second traffic type based on the second payload size.

In some embodiments, said determining the amount of the first portion of the communication resource comprises: determining the amount of the first portion of the communication resource as the amount of the communication resource multiplied by the first ratio.

In some embodiments, said determining the first payload size comprises: determining a size of a first codeword based on the amount of the first portion of the communication resource and the modulation-and-coding scheme for the first traffic type; and determining the first payload size based on the size of the first codeword and a code rate for the first traffic type.

In some embodiments, said determining the first payload size further comprises: converting the determined first payload size to a greatest integer smaller than or equal to the determined first payload size.

In some embodiments, said determining the first payload size comprises: determining the first payload size based on a size of a buffer for the first traffic type; and determining a code rate of the first codeword for the first traffic type based on the first payload size.

In some embodiments, said determining the amount of the second portion of the communication resource comprises: determining the amount of the second portion of the communication resource as the amount of the communications resource minus the amount of the first portion of the communication resource.

In some embodiments, the third method further comprises: determining a size of a second codeword based on the amount of the second portion of the communication resource and a modulation-and-coding scheme for the second traffic type.

In some embodiments, said determining the second payload size comprises: determining the second payload size based on the size of the second codeword and a code rate for the second traffic type.

In some embodiments, said determining the payload size of the data piece of the second traffic type comprises: determining the payload size of the data piece of the second traffic type as the second payload size minus a multiplication of the first payload size and the second ratio.

In some embodiments, the single data block is a single transport block.

According to one aspect of this disclosure, there is provided a fourth method comprising: receiving one or more downlink control information messages for scheduling a plurality of uplink or downlink transmissions of a plurality of data piece of a plurality of traffic types, each uplink or downlink transmission being for transmission of a data piece of a respective traffic type, the plurality of traffic types comprising a first traffic type for transmission in a first data block via a first communication resource and a second traffic type in a second data block via a second communication resource; a joint coding method such as a mixed-traffic coding method is used for encoding the data piece of the traffic type into a first codeword for transmission via the first communication resource, and encoding at least a portion of the data piece of the first traffic type with the data piece of the second traffic type into a second codeword for transmission via the second communication resource.

In some embodiments, the fourth method further comprises: receiving or transmitting the plurality of data pieces in accordance with said scheduling specified in the downlink control information message.

In some embodiments, the plurality of data pieces of the plurality of traffic types comprises data generated by different applications that needs to be transmitted and/or received in different ways, data with different QoS requirements, data with different data rate requirements, data with different reliability requirements, data with different latency requirements, data with different priority requirements, and/or data to be transmitted in different logical channels.

In some embodiments, the plurality of traffic types comprises at least two types selected from ultra-reliable low latency communications, enhanced mobile broadband, massive machine type communications, and terabyte-per-second communications.

In some embodiments, the one or more downlink control information messages comprise a first downlink control information message for scheduling the uplink or downlink transmission of the data piece of the second traffic type; and the first downlink control information message comprises: a first indication for indicating the use of the joint coding method, a second indication for indicating the second traffic type, and a third indication for indicating the first data block.

In some embodiments, the first downlink control information message further comprises: a fourth indication for indicating an amount of the at least portion of the data piece of the first traffic type.

In some embodiments, the fourth indication is a first ratio of the at least portion of the data piece of the first traffic type over the data piece of the first traffic type.

In some embodiments, the first indication is a one-bit field.

In some embodiments, the third indication is a hybrid-automatic-repeat-request process number, a multiplexing index, a priority index, a service index, a traffic-type indication, or a logical channel index.

In some embodiments, the first downlink control information message further comprises: a fifth indication for indicating the second data block.

According to one aspect of this disclosure, there is provided one or more circuits for performing the above-described first, second, third, and/or fourth method.

According to one aspect of this disclosure, there is provided one or more processors functionally connected to one or more memories for performing the above-described first, second, third, and/or fourth method.

According to one aspect of this disclosure, there is provided an apparatus comprising: one or more processors functionally connected to one or more memories for performing the above-described first, second, third, and/or fourth method.

According to one aspect of this disclosure, there is provided an apparatus comprising: one or more processors functionally connected to one or more non-transitory computer-readable storage media storing instructions; wherein the instructions, when executed, cause one or more circuits to perform the above-described first, second, third, and/or fourth method.

According to one aspect of this disclosure, there is provided one or more non-transitory computer-readable storage media comprising computer-executable instructions, wherein the instructions, when executed, cause one or more circuits such as one or more processors to perform the above-described first method.

According to one aspect of this disclosure, there is provided an apparatus, and configured to perform any one of above-mentioned methods and their embodiments. Specifically, the apparatus includes one or more units configured to perform any one of above-mentioned methods and their embodiments.

According to one aspect of this disclosure, there is provided one or more computer-readable storage media. The one or more computer-readable storage media store a computer program, and when the computer program is executed by an apparatus, the apparatus is enabled to implement any one of above mentioned methods and their embodiments.

According to one aspect of this disclosure, there is provided a computer program product including one or more instructions. When the instructions are executed by a computer, the apparatus is enabled to implement any one of above-mentioned methods and their embodiments.

According to one aspect of this disclosure, there is provided a computer program. When the computer program is executed by a computer, an apparatus is enabled to implement any one of above-mentioned methods and their embodiments.

According to one aspect of this disclosure, there is provided a communication system. The communication system includes a first communication-node and/or a second communication-node, the first communication-node is configured to perform any one of above-mentioned methods and their embodiments regarding with the first communication-node as stated above, and the second communication-node is configured to perform any one of above mentioned methods and their embodiments regarding with the second communication-node as stated above.

According to one aspect of this disclosure, there is provided an apparatus for implementing any one of above-mentioned methods and their embodiments in any possible implementation of the foregoing aspects.

The methods disclosed herein may improve the efficiency of user equipment (UE) in transmitting messages of multiple traffic types. Furthermore, the mixed-traffic coding method may also improve reliability of URLLC without dropping or negatively impacting eMBB traffic, which requires less retransmission. The logical channel index list allows a transmit-and-receive point (TRP) to control which traffic data to be used for joint channel coding.

By integrating various services into a single error-correction code such as a single forward error correction (FEC) code, with awareness of service priority (target block error rate (BLER), latency and sources), the mixed-traffic coding method disclosed herein enables both self decodability and enhanced joint decodability. In some examples, a joint decoding procedure may be used after a decoding failure, and a request for retransmission is used if the joint decoding procedure also fails to decode the mixed-traffic codewords.

### BRIEF DESCRIPTION OF THE DRAWINGS

For a more complete understanding of this disclosure, reference is made to the following description and accompanying drawings, in which:

FIGS. 1 and 2 are simplified schematic diagrams showing the structure of a communication system, according to some embodiments of this disclosure;

FIG. 3 is a simplified schematic diagram showing a user equipment (UE), a terrestrial transmit-and-receive point (T-TRP), and a non-terrestrial transmit-and-receive points (NT-TRP) of the communication system shown in FIG. 1;

FIG. 4 is a simplified schematic diagram showing units or modules in a device, such as in UE or in TRP of the communication system shown in FIG. 1;

FIG. 5 is a simplified schematic diagram showing a TRP providing a plurality of wireless communication services (S₁, S₂, . . . ) or traffic types to a plurality of UEs, according to some embodiments of this disclosure;

FIG. 6 is a flowchart showing a procedure performed on a transmitter side for encoding data of various traffic types using a mixed-traffic coding method, according to some embodiments of this disclosure;

FIG. 7 is a simplified schematic diagram showing a code block or a joint codeword comprising a first codeword and a second, jointly encoded codeword, according to some embodiments of this disclosure;

FIG. 8 is a flowchart showing a procedure performed by a receiver for decoding the received first and second codewords of the code block shown in FIG. 7 using the mixed-traffic coding method, according to some embodiments of this disclosure;

FIG. 9 is a simplified schematic diagram showing decoding of the code block shown in FIG. 7, according to some embodiments of this disclosure, wherein the decoding of the first codeword is successful;

FIG. 10 is a simplified schematic diagram showing decoding of a code block, according to some embodiments of this disclosure, wherein the decoding of the first codeword failed;

FIG. 11 is a flowchart showing a successive-embedding procedure performed on a transmitter side (for example, performed by a mixed-traffic encoder) for encoding n messages of various traffic types using the mixed-traffic coding method, according to some embodiments of this disclosure;

FIG. 12 is a schematic diagram illustrating the successive-embedding procedure shown in FIG. 11;

FIG. 13 is a flowchart showing a multi-to-one-embedding procedure performed on a transmitter side (for example, performed by a mixed-traffic encoder) for encoding n messages of various traffic types using the mixed-traffic coding method, according to some embodiments of this disclosure;

FIG. 14 is a schematic diagram illustrating the multi-to-one-embedding procedure shown in FIG. 13;

FIG. 15 shows an exemplary application of a robot arm using the mixed-traffic coding method;

FIG. 16 is a schematic diagram illustrating a joint code block generated by the robot arm shown in FIG. 15 using the mixed-traffic coding method, wherein the joint code block comprises a plurality of symbols or bits corresponding to ultra-reliable low latency communications (URLLC), enhanced mobile broadband (eMBB), and massive machine type communications (mMTC) messages, according to some embodiments of this disclosure;

FIG. 17 is a schematic diagram illustrating a decoding process of the joint code block shown in FIG. 16, according to some embodiments of this disclosure, wherein the decoding of the URLLC codeword is successful;

FIG. 18 is a schematic diagram illustrating a decoding process of the joint code block shown in FIG. 16, according to some embodiments of this disclosure, wherein the decoding of the URLLC codeword is unsuccessful;

FIG. 19 is a schematic diagram illustrating a decoding process of the joint code block shown in FIG. 16, according to some embodiments of this disclosure, wherein the decoding of the URLLC codeword is unsuccessful, and the receiver requests retransmission using incremental redundancy (IR) HARQ;

FIG. 20 is a schematic diagram illustrating a method wherein a UE 114 separately send multiple scheduling requests (SRs) to a TRP, each separate SR corresponding to a traffic type for scheduling transmission of message of the specific traffic type;

FIG. 21 is a schematic diagram illustrating a SR process for scheduling transmission of messages of a plurality of traffic types, according to some embodiments of this disclosure;

FIG. 22 is a schematic diagram illustrating a TRP sending a downlink control information (DCI) to a UE to schedule multiple-traffic data transmission in one transport block (TB) transmitted in a physical uplink shared channel (PUSCH), according to some embodiments of this disclosure;

FIG. 23 is a flowchart showing the steps of a procedure performed by a UE for determining the payload sizes for different traffic types, according to some embodiments of this disclosure;

FIG. 24 shows an example of payload-size determination, according to some embodiments of this disclosure;

FIG. 25 is a flowchart showing a procedure for configuring traffic-type indication in DCI, according to some embodiments of this disclosure; and

FIG. 26 is a schematic diagram illustrating a TRP scheduling mixed-traffic transmission by scheduling separate transmissions for different traffic types, according to some embodiments of this disclosure.

### DETAILED DESCRIPTION OF THE ILLUSTRATIVE EMBODIMENTS

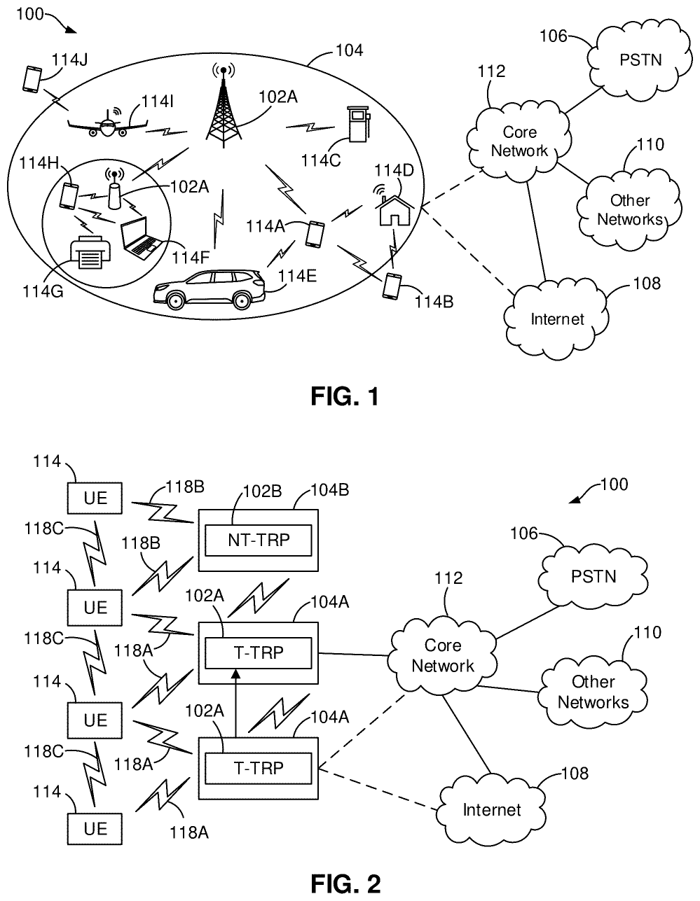

Referring to FIG. 1, as an illustrative example without limitation, a simplified schematic illustration of a communication system is provided. The communication system 100 comprises a radio access network (RAN) 104. The RAN 104 may be a next generation (for example, sixth generation (6G) or later) RAN, or a legacy (for example, fifth-generation (5G), fourth-generation (4G), third-generation (3G), or second-generation (2G)) RAN. One or more user equipments (UEs) 114A to 114J (generically referred to as 114) may be interconnected to one another or connected to one or more network nodes 102A in the RAN 104. A core network 112 may be a part of the communication system and may be dependent or independent of the radio access technology used in the communication system 100. Also, the communication system 100 comprises a public switched telephone network (PSTN) 106, the internet 108, and other networks 110.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, and unicast, and/or the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and/or the like). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. As those skilled in the art will appreciate, the heterogeneous network may achieve improved overall performance through efficient multi-link joint operation, more flexible functionality sharing, and faster physical layer link switching between terrestrial networks (TNs) and non-terrestrial networks (NTNs).

The terrestrial communication system and the non-terrestrial communication system may be considered sub-systems of the communication system 100. In the example shown, the communication system 100 includes UEs 114, RANs 104A (also called “terrestrial communication networks”), non-terrestrial communication networks 104B, a core network 112, a public switched telephone network (PSTN) 106, the internet 108, and other networks 110. The RANs 104A include respective base stations (BSs) 102A, which may be generically referred to as terrestrial transmit-and-receive points (T-TRPs) 102A. The non-terrestrial communication network 104B includes an access node 102B, which may be generically referred to as a non-terrestrial transmit-and-receive point (NT-TRP) 102B. The T-TRPs 102A and the NT-TRP 102B may be generally referred to as TRPs or access nodes 102.

Any UE 114 may be alternatively or additionally configured to interface, access, or communicate with any other T-TRP 102A and NT-TRP 102B, the internet 108, the core network 112, the PSTN 106, the other networks 110, or any combination of the preceding. In some examples, UE 114 may communicate an uplink (UL) and/or downlink (DL) transmission over a terrestrial interface 118A with T-TRP 102A. In some examples, A UE 114 may communicate a UL and/or DL transmission over a non-terrestrial interface 118B with NT-TRP 102B. In some examples, the UEs 114 may also communicate directly with one another via one or more sidelink air interfaces 118C.

The air interfaces 118A and 118C may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA; also known as discrete Fourier transform spread OFDMA, DFT-s-OFDMA) in the air interfaces 118A and 118C. The air interfaces 118A and 118C may utilize other higher dimension signal spaces, which may involve a combination of orthogonal and/or non-orthogonal dimensions.

The non-terrestrial air interface 118B may enable communication between a UE 114 and one or multiple NT-TRPs 102B via a wireless link or simply a link. For some examples, the link is a dedicated connection for unicast transmission, a connection for broadcast transmission, or a connection between a group of UEs 114 and one or multiple NT-TRPs 102B for multicast transmission.

The RANs 104A are in communication with the core network 112 to provide the UEs 114 with various services such as voice, data, and other services. The RANs 104A and/or the core network 112 may be in direct or indirect communication with one or more other RANs (not shown), which may or may not be directly served by core network 112, and may or may not employ the same radio access technology as RANs 104A. The core network 112 may also serve as a gateway access between (i) the RANs 104A, or UEs 114, or both, and (ii) other networks (such as the PSTN 106, the internet 108, and the other networks 110). In addition, some or all of the UEs 114 may include functionality for communicating with different wireless networks over different wireless links using different wireless technologies and/or protocols. Instead of wireless communication (or in addition thereto), the UEs 114 may communicate via wired communication channels to a service provider or switch (not shown), and to the internet 108. PSTN 106 may include circuit switched telephone networks for providing plain old telephone service (POTS). Internet 108 may include a network of computers and subnets (intranets) or both, and incorporate protocols, such as internet protocol (IP), transmission control protocol (TCP), user datagram protocol (UDP). UEs 114 may be multimode devices capable of operation according to multiple radio access technologies, and incorporate multiple transceivers necessary to support such.

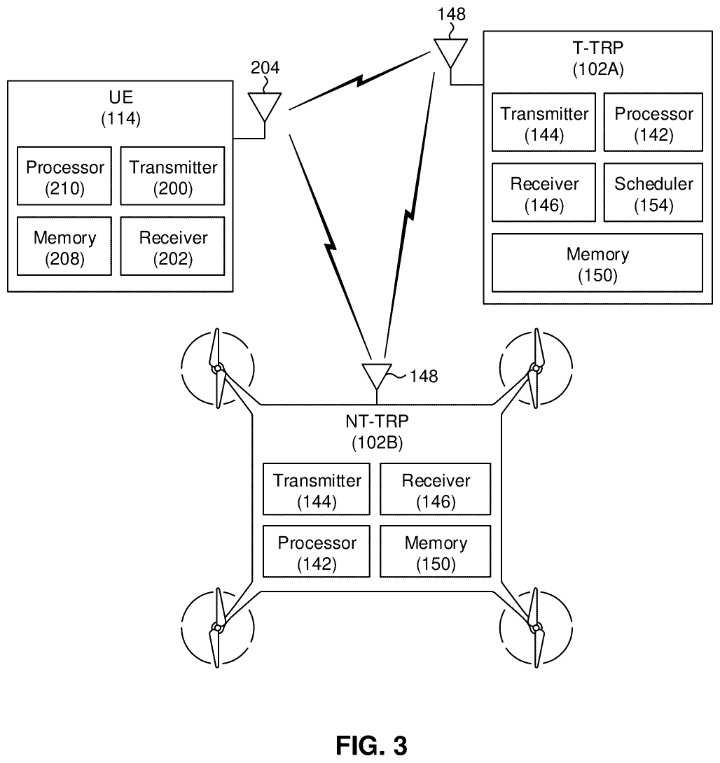

FIG. 3 illustrates an example of a UE 114, a T-TRP 102A, and a NT-TRP 102B. The UE 114 is used to connect persons, objects, machines, and/or the like. The UE 114 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, and/or the like.

Each UE 114 represents any suitable end-user device for wireless operation and may include such devices (or may be referred to) as a user device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, a wearable device (such as a watch, a pair of glasses, a head mounted equipment, and/or the like), an industrial device, a robot, or apparatus (for example, communication module, modem, or chip) in or comprising the forgoing devices, among other possibilities. Future generation UEs 114 may be referred to using other terms. Each UE 114 connected to T-TRP 102A and/or NT-TRP 102B may be dynamically or semi-statically turned-on (that is, established, activated, or enabled), turned-off (that is, released, deactivated, or disabled) and/or configured in response to one of more of: connection availability and connection necessity.

The T-TRP 102A may be known by other names in some implementations, such as a base station, a base transceiver station (BTS), a radio base station, a network node, a network device, a device on the network side, a transmit/receive node, a Node B, an evolved NodeB (eNodeB or eNB), a home eNodeB, a next generation NodeB (gNB), a transmission point (TP), a site controller, an access point (AP), or a wireless router, a relay station, a remote radio head, a terrestrial node, a terrestrial network device, or a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 102A may be macro BSs, pico BSs, relay node, donor node, or the like, or combinations thereof. The T-TRP 102A may refer to the forgoing devices or refer to an apparatus (for example, a communication module, a modem, a chip, or the like) in the forgoing devices.

In some embodiments, the parts of the T-TRP 102A may be distributed. For example, some of the modules of the T-TRP 102A may be located remote from the equipment housing the antennas of the T-TRP 102A, and may be coupled to the equipment housing the antennas over a communication link (not shown) sometimes known as front haul, such as common public radio interface (CPRI). Therefore, in some embodiments, the term T-TRP 102A may also refer to modules on the network side that perform processing operations, such as determining the location of the UE 114, resource allocation (scheduling), message generation, and encoding/decoding, and that are not necessarily part of the equipment housing the antennas of the T-TRP 102A. The modules may also be coupled to other T-TRPs. In some embodiments, the T-TRP 102A may actually be a plurality of T-TRPs that are operating together to serve the UE 114, for example, through coordinated multipoint transmissions.

The T-TRP 102A comprises one or more circuits (such as one or more electronic circuits and/or one or more optical circuits) forming various components. For example, the T-TRP 102 may comprise at least one transmitter 144 and at least one receiver 146 coupled to one or more antennas 148. Only one antenna 148 is illustrated. One, some, or all of the antennas may alternatively be panels. The transmitter 144 and the receiver 146 may be integrated as a transceiver. The T-TRP 102A may further comprise at least one processor 142 for performing operations including those related to: preparing a transmission for DL transmission to the UE 114, processing an UL transmission received from the UE 114, preparing a transmission for backhaul transmission to NT-TRP 102B, and processing a transmission received over backhaul from the NT-TRP 102B. Processing operations related to preparing a transmission for DL or backhaul transmission may include operations such as encoding, modulating, precoding (for example, multiple input multiple output (MIMO) precoding), transmit beamforming, and generating symbols for transmission. Processing operations related to processing received transmissions in the UL or over backhaul may include operations such as receive beamforming, and demodulating and decoding received symbols. The processor 142 may also perform operations relating to network access (for example, initial access) and/or DL synchronization, such as generating the content of synchronization signal blocks (SSBs), generating the system information, and/or the like. In some embodiments, the processor 142 also generates the indication of beam direction, for example, BAI, which may be scheduled for transmission by a scheduler 154. The processor 142 performs other network-side processing operations described herein, such as determining the location of the UE 114, determining where to deploy NT-TRP 102B, and/or the like. In some embodiments, the processor 142 may generate signaling, for example, to configure one or more parameters of the UE 114 and/or one or more parameters of the NT-TRP 102B. Any signaling generated by the processor 142 is sent by the transmitter 144. Note that “signaling”, as used herein, may alternatively be called control signaling. Dynamic signaling may be transmitted in a control channel, for example, a physical downlink control channel (PDCCH), and static or semi-static higher layer signaling may be included in a packet transmitted in a data channel, for example, in a physical downlink shared channel (PDSCH), in which case the signaling may be known as higher-layer signaling, static signaling, or semi-static signaling. Higher-layer signaling may also refer to radio resource control (RRC) protocol signaling or media access control-control element (MAC-CE) signaling.

A scheduler 154 may be coupled to the processor 142. The scheduler 154 may be included within or operated separately from the T-TRP 102A, which may schedule UL, DL, and/or backhaul transmissions, including issuing scheduling grants and/or configuring scheduling-free (for example, “configured grant”) resources. The T-TRP 102A may further comprise a memory 150 for storing information and data. The memory 150 stores instructions and data used, generated, or collected by the T-TRP 102A. For example, the memory 150 may store software instructions or modules configured to implement some or all of the functionality and/or embodiments described herein and that are executed by the processor 142.

Although not illustrated, the processor 142 may form part of the transmitter 144 and/or receiver 146. Also, although not illustrated, the processor 142 may implement the scheduler 154. Although not illustrated, the memory 150 may form part of the processor 142.

The processor 142, the scheduler 154, the processing components of the transmitter 144, and the processing components of the receiver 146 may each be implemented by the same or different one or more processors that are configured to execute instructions stored in a memory, for example, in memory 150. Alternatively, some or all of the processor 142, the scheduler 154, the processing components of the transmitter 144, and the processing components of the receiver 146 may be implemented using dedicated circuitry, such as a field-programmable gate array (FPGA), a graphical processing unit (GPU), or an application-specific integrated circuit (ASIC).

Although the NT-TRP 102B is illustrated as a drone only as an example, the NT-TRP 102B may be implemented in any suitable non-terrestrial form, such as satellites and high altitude platforms, including international mobile telecommunication base stations and unmanned aerial vehicles, for example. Also, the NT-TRP 102B may be known by other names in some implementations, such as a non-terrestrial node, a non-terrestrial network device, or a non-terrestrial base station.

The NT-TRP 102B comprises one or more circuits (such as one or more electronic circuits and/or one or more optical circuits) forming various components, and may have a similar structure as the T-TRP 102A. For example, the NT-TRP 102B may comprise a transmitter 144 and a receiver 146 coupled to one or more antennas 148. Only one antenna 148 is illustrated to avoid congestion in the drawing. One, some, or all of the antennas may alternatively be panels. The transmitter 144 and the receiver 146 may be integrated as a transceiver. The NT-TRP 102B further includes at least one processor 142 for performing operations including those related to: preparing a transmission for DL transmission to the UE 114, processing an UL transmission received from the UE 114, preparing a transmission for backhaul transmission to T-TRP 102A, and processing a transmission received over backhaul from the T-TRP 102A. Processing operations related to preparing a transmission for DL or backhaul transmission may include operations such as encoding, modulating, precoding (for example, MIMO precoding), transmit beamforming, and generating symbols for transmission. Processing operations related to processing received transmissions in the UL or over backhaul may include operations such as receive beamforming, and demodulating and decoding received symbols. In some embodiments, the processor 142 implements the transmit beamforming and/or receive beamforming based on beam direction information (for example, BAI) received from T-TRP 102A. In some embodiments, the processor 142 may generate signaling, for example, to configure one or more parameters of the UE 114. In some embodiments, the NT-TRP 102B implements physical layer processing, but does not implement higher layer functions such as functions at the medium access control (MAC) or radio link control (RLC) layer. As this is only an example, more generally, the NT-TRP 102B may implement higher layer functions in addition to physical layer processing.

The NT-TRP 102B further includes a memory 150 for storing information and data. Although not illustrated, the processor 142 may form part of the transmitter 144 and/or receiver 146. Although not illustrated, the memory 150 may form part of the processor 142.

The processor 142, the processing components of the transmitter 144, and the processing components of the receiver 146 may each be implemented by the same or different one or more processors that are configured to execute instructions stored in a memory, for example, in memory 150. Alternatively, some or all of the processor 142, the processing components of the transmitter 144, and the processing components of the receiver 146 may be implemented using dedicated circuitry, such as a programmed FPGA, a hardware accelerator (for example, a GPU or artificial intelligence (AI) accelerator), or an ASIC. In some embodiments, the NT-TRP 102B may actually be a plurality of NT-TRPs that are operating together to serve the UE 114, for example, through coordinated multipoint transmissions.

The T-TRP 102A, the NT-TRP 102B, and/or the UE 114 may include other components, but these have been omitted for the sake of clarity.

The UE 114 comprises one or more circuits (such as one or more electronic circuits and/or one or more optical circuits) forming various components. More specifically, the UE 114 includes a transmitter 200 and a receiver 202 coupled to one or more antennas 204. Only one antenna 204 is illustrated to avoid congestion in the drawing. One, some, or all of the antennas may alternatively be panels. The transmitter 200 and the receiver 202 may be integrated, for example, as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The UE 114 includes at least one memory 208. The memory 208 stores instructions and data used, generated, or collected by the UE 114. For example, the memory 208 may store software instructions or modules configured to implement some or all of the functionality and/or embodiments described herein and that are executed by at least one processing unit (for example, the at least one processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The UE 114 may further include one or more input/output devices (not shown) or interfaces (such as a wired interface to the internet 108 in FIG. 1). The input/output devices permit interaction with a user or other devices in the network. Each input/output device includes any suitable structure for providing information to or receiving information from a user, and/or for network interface communications. Suitable structures include, for example, a speaker, a microphone, a keypad, a keyboard, a display, a touch screen, a network interface, and/or the like.

The UE 114 further includes at least one processor 210 for performing operations including those operations related to preparing a transmission for UL transmission to the T-TRP 102A and/or NT-TRP 102B, those operations related to processing DL transmissions received from the T-TRP 102A and/or NT-TRP 102B, and those operations related to processing sidelink transmission to and from another UE 114. Processing operations related to preparing a transmission for UL transmission may include operations such as encoding, modulating, transmit beamforming, and generating symbols for transmission. Processing operations related to processing DL transmissions may include operations such as receive beamforming, demodulating and decoding received symbols. Depending upon the embodiment, a DL transmission may be received by the receiver 202, possibly using receive beamforming, and the processor 210 may extract signaling from the DL transmission (for example, by detecting and/or decoding the signaling). An example of signaling may be a reference signal transmitted by the T-TRP 102A and/or NT-TRP 102B. In some embodiments, the processor 142 implements the transmit beamforming and/or the receive beamforming based on the indication of beam direction, for example, beam angle information (BAI), received from T-TRP 102. In some embodiments, the processor 210 may perform operations relating to network access (for example, initial access) and/or DL synchronization, such as operations relating to detecting a synchronization sequence, decoding and obtaining the system information, and/or the like. In some embodiments, the processor 210 may perform channel estimation, for example, using a reference signal received from the T-TRP 102A and/or NT-TRP 102B.

Although not illustrated, the processor 210 may form part of the transmitter 200 and/or part of the receiver 202. Although not illustrated, the memory 208 may form part of the processor 210.

The processor 210, the processing components of the transmitter 200, and the processing components of the receiver 202 may each be implemented by the same or different one or more processors that are configured to execute instructions stored in a memory (for example, in memory 208). Alternatively, some or all of the processor 210, the processing components of the transmitter 200, and the processing components of the receiver 202 may be implemented using dedicated circuitry, such as a programmed FPGA, an ASIC, or a hardware accelerator such as a GPU or an AI accelerator.

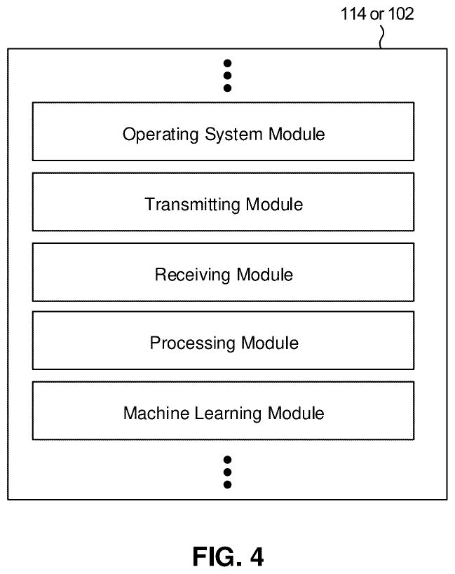

One or more steps of the embodiment methods provided herein may be performed by corresponding units or modules, as shown in FIG. 4, which illustrates units or modules in a device, such as in a UE 114 or in a TRP 102. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the UEs 114 and TRP 102 are known to those of skill in the art. As such, these details are omitted here.

MIMO technology allows an antenna array of multiple antennas to perform signal transmissions and receptions to meet high transmission rate requirement. The UEs 114 and/or TRPs 102 may use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above TRP 102 configured with a large number of antennas has gained wide attentions from the academia and the industry. In the large-scale MIMO system, the TRP 102 may be generally configured with more than ten antenna units (such as antennas 148 shown in FIG. 3), and serves for dozens of the UE 114 in the meanwhile. A large number of antenna units of the TRP 102 may greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the TRP 102 of each cell may communicate with many UEs 114 in the cell on the same time-frequency resource at the same time, thus greatly increasing the spectrum efficiency. A large number of antenna units of the TRP 102 also enable each user to have improved spatial directivity for UL and DL transmission, so that the transmitting power of the TRP 102 and/or a UE 114 is obviously reduced, and the power efficiency is greatly increased. When the antenna number of the TRP 102 is sufficiently large, random channels between each UE 114 and the TRP 102 may approach to be orthogonal, and the interference between the cell and the users and the effect of noises may be eliminated. The plurality of advantages described above enable the large-scale MIMO to have a magnificent application prospect.

A MIMO system may include a receiver connected to a receiving (Rx) antenna, a transmitter connected to transmitting (Tx) antenna, and a signal processor connected to the transmitter and the receiver. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible units or possible configurable parameters or in some embodiments of a MIMO system include:

Panel: unit of antenna group, or antenna array, or antenna sub-array which may control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, antenna port(s) identifier, channel state information reference signal (CSI-RS) resource identifier, SSB resource identifier, sounding reference signal (SRS) resource identifier, codebook indication, beam direction indication, other reference signal resource identifier, and/or the like.

### Error-Correction Coding Methods for Mixed Traffic

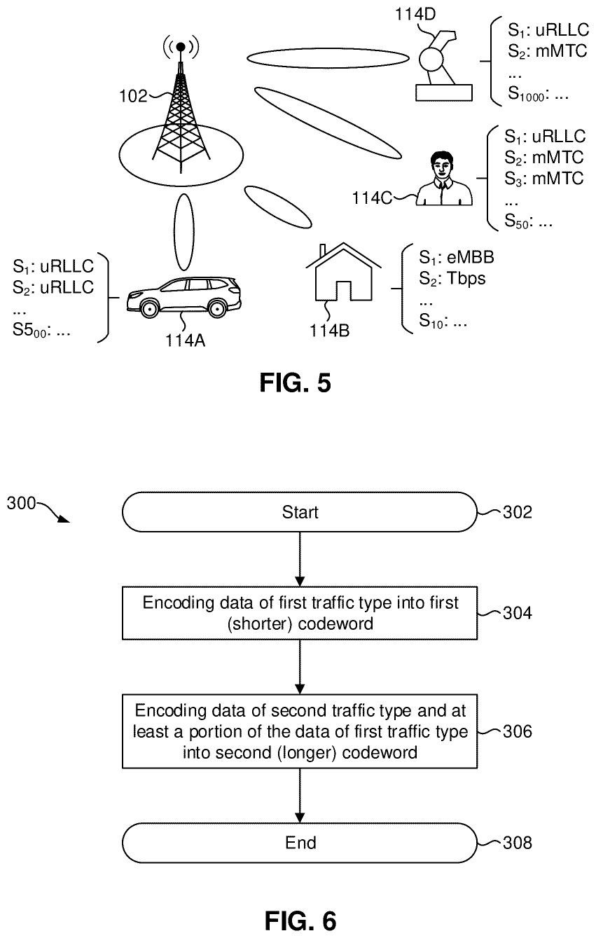

As described above, multiple services may converge or be integrated into one physical wireless link, and these services may have diverse key performance indicators (KPIs). For example, as shown in FIG. 5, a TRP 102 may provide a plurality of wireless communication services (S₁, S₂, . . . ) or traffic types to each of a plurality of UEs 114 to meet the needs of different service types and different numbers of services thereof. The plurality of UEs 114 may comprise any suitable types of UEs such as a vehicle-based device or UE 114A, a home-based or other premises-based device or UE 114B, a user device 114C, an industrial or machine-based device or UE 114D, and the like. Examples of the wireless communication services or traffic types may be ultra-reliable low latency communications (URLLC), massive machine type communications (mMTC), enhanced mobile broadband (eMBB), terabyte per second (Tbps) communications, and the like. Each wireless communication service may be treated as a medium access (MA), such as intra-user medium access, spatial-coupled low-density parity check (LDPC) code, polar code for medium access control (MAC), and/or the like, and the plurality of wireless communication services may be integrated into one beam.

To accommodate different types of data transfer services, multiple types of logical channels are defined in communication standards. In the 5G NR standard, for example, each logical channel supports the transfer of a particular type of information processed at the MAC layer. Each logical channel type is defined by the type of information transferred therein. A logical channel may be used for traffic (that is, data of a particular service type). Each logical channel may be configured via RRC signaling with different properties including priority and other attributes related to the traffic type.

For example, the RRC signaling controls the scheduling of uplink data by configuring each logical channel per MAC entity. The RRC signaling may configure a logical channel via a LogicalChannelConfig information element. The information element may contain the following information to be used for prioritization of the logical channel:
priority, where an increasing priority value indicates a lower priority level;
prioritisedBitRate, which sets the prioritized bit rate (PBR);
bucketSizeDuration, which sets the bucket size duration (BSD).

In channel coding, the coding gain depends heavily on code length and code rate. Longer codes and lower code rates typically lead to better error correction performance. In existing channel coding designs, code lengths and rates are adjusted to the current channel states in an adaptive way. For example, the code lengths and rates may be adjusted based on channel quality indicator (CQI) feedback and scheduling algorithms.

In conventional mobile communication systems, data from different applications or sources are grouped into separate bulks of payloads, which in turn are encoded, transmitted, and decoded separately.

Furthermore, in conventional systems, a UE 114 may experience a conflict in resources used to transmit data such as PUSCH, and control information such as PUCCH. A priority handling rule in NR defines which resource should be dropped (not transmitted) in case of conflict.

When a UE 114 is scheduled for a transmission, the UE 114 selects a logical channel based on its priority and other information. The UE 114 maps the logical channel to a transport channel to be used for encoding. The encoding operation and physical layer transmission scheme is independent of the traffic type. Therefore, different traffic types are usually separately encoded (that is, the encoding procedure is performed without regard to the traffic type).

Herein, the term “traffic type” refers to a type of traffic or data that needs to be transmitted and/or received in a specific way or manner, such as data generated by different applications that needs to be transmitted and/or received in different ways or manners, data with different QoS requirements, data with different data rate requirements, data with different reliability requirements, data with different latency requirements, data with different priority requirements, data to be transmitted in different logical channels, and/or the like. A specific traffic type and its specific way or manner for transmission/receiving are usually associated with and/or determined by the specific characteristics of the traffic or data, for example, traffic or data generated and/or used by a specific type of application, traffic or data having a specific type of information, a specific set of requirements (for example, specific requirements in QoS, data rate, reliability, latency, priority, and/or the like), and/or any other features that may lead to a specific way or manner for transmission/receiving.

For example, different traffic types may refer to different communication traffic or data that carries different types of information, for example, voice traffic, video traffic, control traffic. Different traffic types may also refer to data or traffic used for different applications such as extended reality (XR) traffic, sensing traffic, and the like; Different traffic types may further refer to traffic or data with different QoS requirements, for example, some traffic types such as eMBB may have higher requirements on data rates, and/or some traffic types such as ULRRC may have higher requirements on reliability and latency. Different traffic types may correspond to different data priorities. For example, a first traffic type may have higher priority that may be indicated by a priority index, while a second traffic may have lower priority that may be indicated by a different priority index.

As those skilled in the art will appreciate, traffic types are often associated with service types. Therefore, these two terms are used interchangeably hereinafter.

When the UE 114 has multiple traffic types (for example, URLLC and eMBB) to transmit, it may not be efficient to separately encode the multiple traffic types. In particular, the reliability of a URLLC code length maybe limited because a short code length usually has lower coding gain.

Separate encoding and transmission of more important data using a lower code rate is not efficient because it cannot benefit from the coding gain of a longer code when the more important data is relatively short. To achieve the same reliability, more code bits are usually required. As such, spectral efficiency will be reduced. Moreover, extra signaling overhead will be required, for example, for resource allocation.

In view of the issues of above-described separate encoding and transmission methods, in some embodiments, the communication system 100, or for example, the TRP 102 and UE 114 may use an error-correction coding method for mixed traffic (also called a “mixed-traffic coding method”) for encoding and decoding data of a plurality of services in different traffic types.

FIG. 6 is a flowchart showing a procedure 300 performed on a transmitter side (for example, performed by a mixed-traffic encoder) for encoding data of various traffic types using the mixed-traffic coding method, according to some embodiments of this disclosure, wherein different traffic types may have different QoS requirements and/or priorities. Herein, a transmitter refers to a device such as a TRP 102 or a UE 114 for transmitting data. Accordingly, a receiver refers to another device such as a UE 114 or a TRP 102 for receiving the data transmitted from the transmitter.

According to the mixed-traffic coding method, data from a plurality of services with different traffic types are grouped into different data groups based on the traffic types. In other words, data of each group has the same traffic type.

As shown in FIG. 6, after the procedure 300 starts (step 302), a first message (containing a first group of one or more information bits, that is, bits before encoding) of a first traffic type (such as URLLC) is encoded into a first codeword using a suitable error-correction coding method such as a suitable forward error correction (FEC) coding method (step 304). At step 306, a second message (containing a second group of one or more information bits) of a second traffic type (such as eMBB) is combined with at least a portion of the first message or at least a portion of the first codeword, and the combination is encoded into a second codeword. Then, the procedure 300 ends (step 308), and the transmitter transmits the first and second codewords 312 and 314.

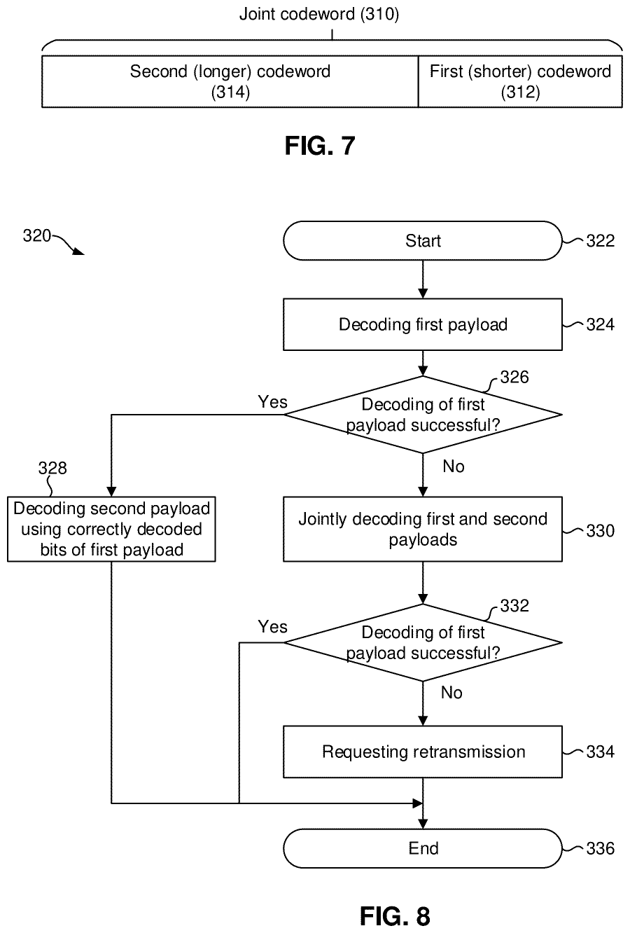

As shown in FIG. 7, with the mixed-traffic coding method, a joint codeword 310 is formed which comprises a first codeword 312 (also denoted a “shorter codeword”) and a second codeword 314 (also denoted a “longer codeword”).

FIG. 8 is a flowchart showing a procedure 320 performed by a receiver for decoding the received first and second codewords 312 and 314. The procedure 320 uses a three-decoding-attempt transmission paradigm, where a new procedure called joint decoding is inserted between a decoding failure and a retransmission request. The first decoding attempt includes steps 324 to 328, the second decoding attempt includes step 330, and the third decoding attempt includes step 334.

After the procedure 320 starts (step 322), the receiver decodes the first payload (step 324). In these embodiments, the receiver may not need to wait for completion of the reception of the first and second codewords 312 and 314. Rather, the receiver may decode the first codeword 312 after receiving the minimum required code bits or log-likelihood ratios (LLRs) of the first codeword 312. If the decoding of the first payload is successful (the “yes” branch of step 326), the receiver uses the correctly decoded bits to enhance the decoding performance of the second payload after the corresponding minimum required code bits are received (step 328). The procedure 320 then ends (step 336).

If the decoding of the first payload fails (the “no” branch of step 326), the receiver does not request a retransmission. Rather, the receiver proceeds to jointly decode with the second payload (step 330). After the decoding of the second payload (regardless successful or failed), the joint decoding feature ensures that the first payload will be successfully decoded with a high probability.

If the decoding of the first payload is successful (the “yes” branch of step 332), the procedure 320 then ends (step 336).

If the decoding of the first payload fails after the second decoding attempt (the “no” branch of step 332), the receiver requests a retransmission from the transmitter (step 334), which incur some delay, but the receiver will decode a third time with both the joint code word and the retransmitted code word. The procedure 320 then ends (step 336). On the other hand, if the decoding of the first codeword 312 fails, successful decoding of the second codeword 314 may facilitate the second effort of decoding the second codeword 314 with increased decoding probability.

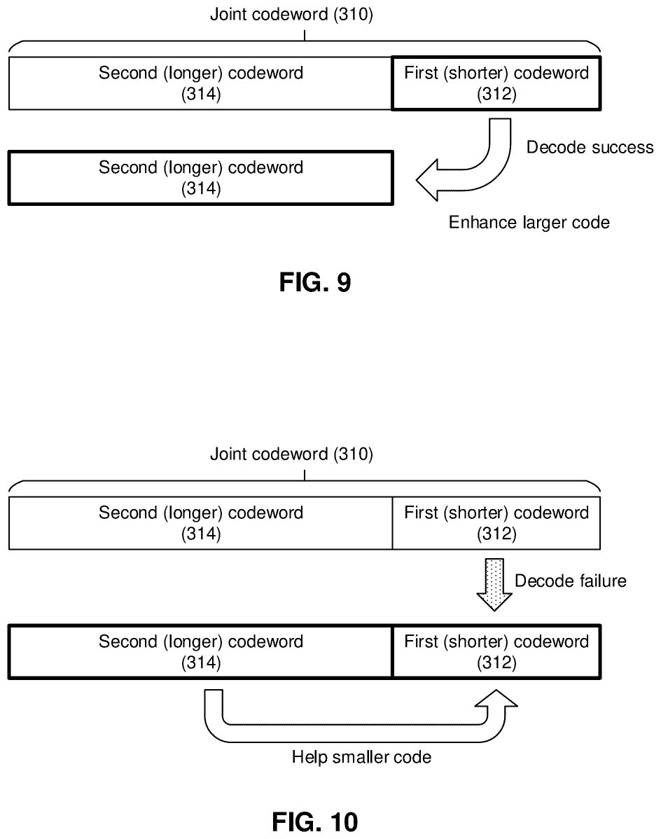

Thus, as shown in FIG. 9, successful decoding of the first codeword 312 may enhance the decoding of the second codeword 314 with increased decoding probability. On the other hand, as shown in FIG. 10, if the decoding of the first codeword 312 fails, successful decoding of the second codeword 314 may facilitate the second effort of decoding the second codeword 314 with increased decoding probability, thereby improving the reliability of decoding of the first codeword 312 and reducing the likelihood of retransmission for the first codeword 312.

In some embodiments, the mixed-traffic coding method is a self-decodable joint coding method for encoding the two messages at steps 304 and 306 such that each of the first and second messages (for example, corresponding to a respective service or traffic type) may be self-decoded, and also support joint decoding to further enhance performance.

By using self-decodable joint coding, each of the first and second messages is encoded such that the codeword thereof is self-decodable, meaning that the codeword of each message may be decoded after collecting a subset of the code bits (or symbols, LLRs); the collected subset of code bits is also a standalone short codeword. In FIGS. 7, 9, and 10, the first codeword 312 is self-decodable.

Meanwhile, the first and second messages, or the second message and a portion of the first message, are also combined (also called “coupled”) and embedded into a longer codeword such that the short and long codewords are jointly decodable. In FIGS. 7, 9, and 10, the first and second codewords 312 and 314 are jointly-decodable.

Such a combination or coupling may be obtained using any suitable methods. For example, in some embodiments, the bits of the first message (being a portion or the entirety of the bits of the first message) may be appended to the second message, and the combination is encoded into a longer codeword 314.

In some other embodiments, the bits from the first message may be transformed (for example, multiplying with a binary matrix) and appended to the second message. The combination is then encoded into a longer codeword 314.

Those skilled in the art will appreciate that, although information bit (message) coupling is used as an example in above description, in some embodiments, coded bits (that is, the bits of the first and second codewords) may alternatively be used for coupling. In the case of systematic codes, message bits are also part of the codeword bits, and thus the two alternatives become the same.

In above examples, two messages are used for encoding to two codewords in a code block. In some embodiments, more than two messages may be encoded to a plurality of codewords in a code block.

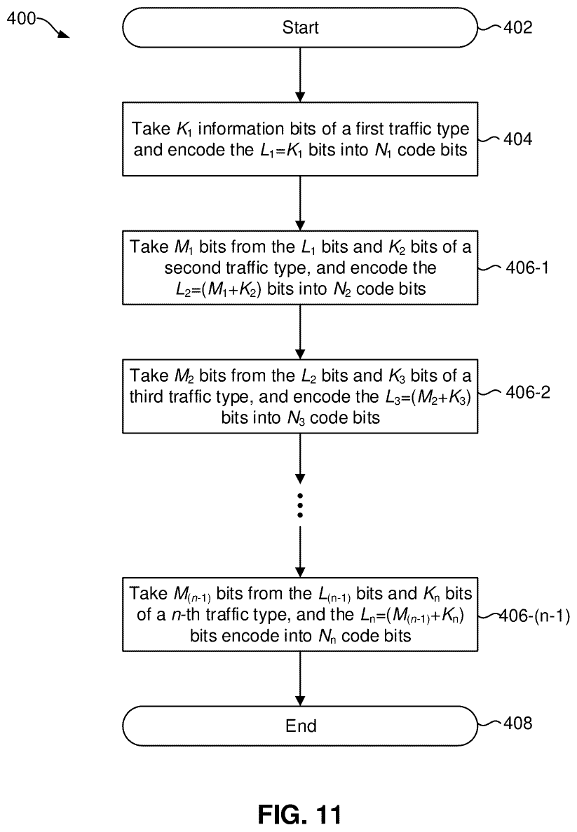

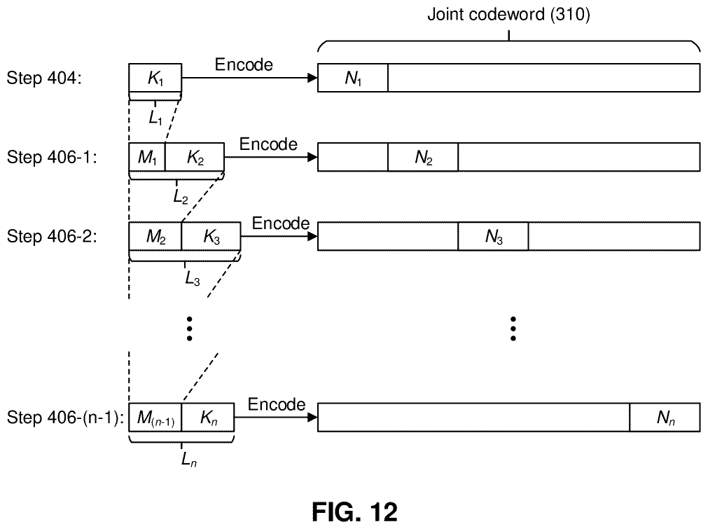

FIG. 11 is a flowchart showing a successive-embedding procedure 400 performed on a transmitter side (for example, performed by a mixed-traffic encoder) for encoding n messages of various traffic types using the mixed-traffic coding method, according to some embodiments of this disclosure, wherein the n messages may be considered being coupled in a chain structure. FIG. 12 is a schematic diagram illustrating the successive-embedding procedure 400.

After the procedure 400 starts (step 402), the encoder takes K₁ information bits of a first message of a first traffic type (such as URLLC) and encodes the L₁=K₁ bits into a first packet of N₁ code bits in the code block 310 (step 404). The code rate is R₁=K₁/N₁.

Step 406 is repeated (n−1) times for encoding (n−1) subsequent messages.

For example, at step 406-1, the encoder takes M₁ bits from the L₁ bits (M₁≤L₁ and thus M₁≤K₁) and K₂ information bits of a second message of a second traffic type (such as eMBB), and encodes the L₂=(M₁+K₂) bits into a second packet of N₂ code bits in the code block 310. The code rate is R₂=L₂/N₂>R₁.

At step 406-2, the encoder takes M₂ bits from the L₂ bits (M₂≤L₂) and K₃ information bits of a third message of a third traffic type (such as mMTC), and encodes the L₃=(M₂+K₃) bits into a third packet of N₃ code bits in the code block 310. The code rate is R₃=L₃/N₃>R₂.

Generally, at step 406-(n−1), the encoder takes M₍ₙ₋₁₎ bits from the L₍ₙ₋₁₎ bits (M₍ₙ₋₁₎≤L₍ₙ₋₁₎) and Kₙ information bits of a n-th message of a n-th traffic type, and encodes the Lₙ=(M₍ₙ₋₁₎+Kₙ) bits into a n-th packet of Nₙ code bits in the code block 310. The code rate is Rₙ=Lₙ/Nₙ>R₍ₙ₋₁₎.

After encoding the n messages, a code block 310 comprising the generated n packets and having a length of (N₁+N₂+N₃+ . . . +Nₙ) bits is obtained, and the procedure 400 ends (step 408). The obtained code block 310 is then transmitted by the transmitter.

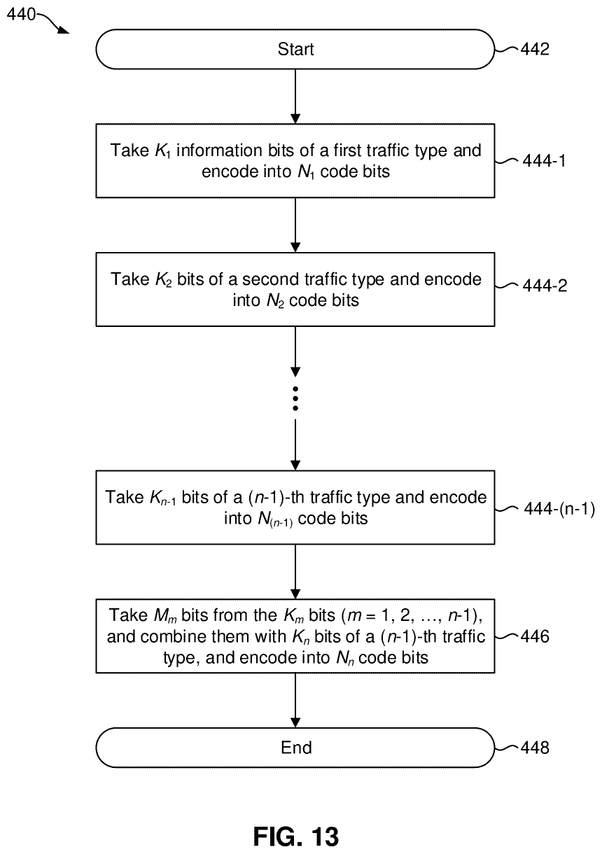

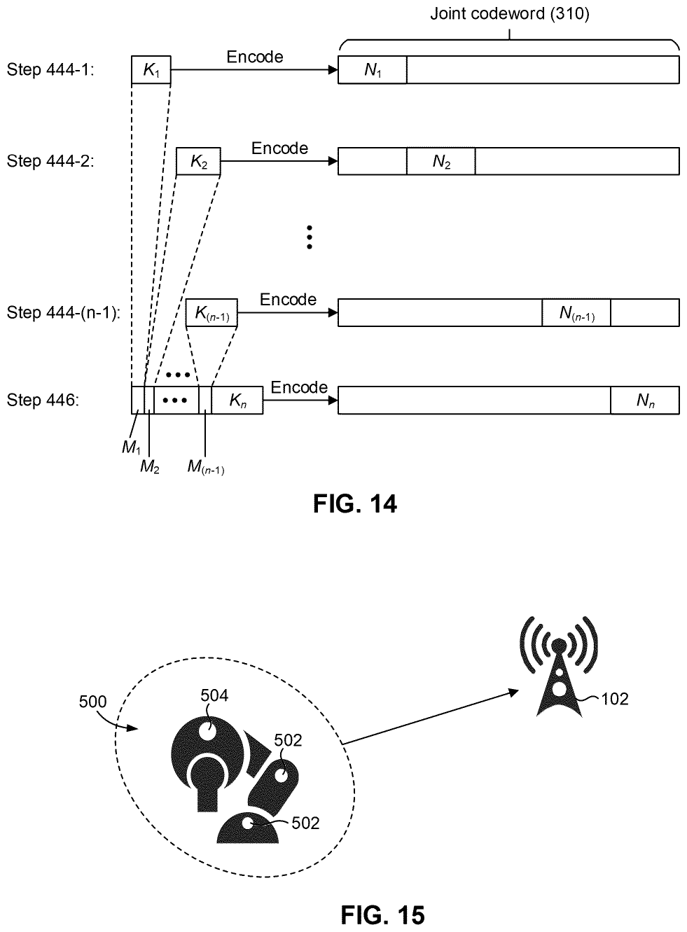

FIG. 13 is a flowchart showing a multi-to-one-embedding procedure 440 performed on a transmitter side (for example, performed by a mixed-traffic encoder) for encoding n messages of various traffic types using the mixed-traffic coding method, according to some embodiments of this disclosure, wherein the n messages may be considered being coupled in a star structure. FIG. 14 is a schematic diagram illustrating the successive-embedding procedure 440.

After the procedure 440 starts (step 442), the encoder repeated the encoding step 444 for (n−1) times to encode (n−1) messages.

For example, at step 444-1, the encoder takes K₁ information bits of a first message of a first traffic type (such as URLLC) and encodes into a first packet of N₁ code bits in the code block 310 (step 444-1). The code rate is R₁=K₁/N₁.

At step 444-2, the encoder takes K₂ information bits of a second message of a second traffic type (such as mMTC) and encodes into a second packet of N₂ code bits in the code block 310. The code rate is R₂=K₂/N₂.

Generally, at step 444-(n−1), the encoder takes K₍ₙ₋₁₎ information bits of a (n−1)-th message of a (n−1)-th traffic type, and encodes into a (n−1)-th packet of N₍ₙ₋₁₎ code bits in the code block 310. The code rate is R₍ₙ₋₁₎=K₍ₙ₋₁₎/N₍ₙ₋₁₎.

At step 446, the encoder takes Mₘ bits from the Kₘ information bits of the m-th message of the m-th traffic type (m=1, 2, . . . , n−1, and Mₘ≤Kₘ), and combine them with Kₙ bits of a n-th message of a n-th traffic type (such as eMBB), and encode into a n-th packet of Nₙ code bits in the code block 310. The code rate is Rₙ=(M₁+M₂+ . . . +M₍ₙ₋₁₎+Kₙ)/Nₙ>R₁, Rₙ>R₂, . . . , Rₙ>R₍ₙ₋₁₎.

After encoding the n messages, a code block 310 comprising the generated n packets and having a length of (M₁+N₂+N₃+ . . . +Nₙ) bits is obtained, and the procedure 440 ends (step 448). The obtained code block 310 is then transmitted by the transmitter.

FIG. 15 shows an exemplary application using the mixed-traffic coding method 400 or 440.

As shown, a device such as a robot arm 500 has a plurality of pivotable linkages 502 and a camera 504. The robot arm 500 is in communication with a TRP 102 and supports URLLC, eMBB and mMTC services. More specifically, the video streaming data captured by the camera 504 is transmitted from the robot arm 500 to the TRP 102 using the eMBB service, the signaling for controlling the pivotable linkages 502 is transmitted from the TRP 102 to the robot arm 500 using the URLLC service, and some delay-insensitive sensing, monitoring, or data reporting are transmitted from the robot arm 500 to the TRP 102 using the mMTC service.

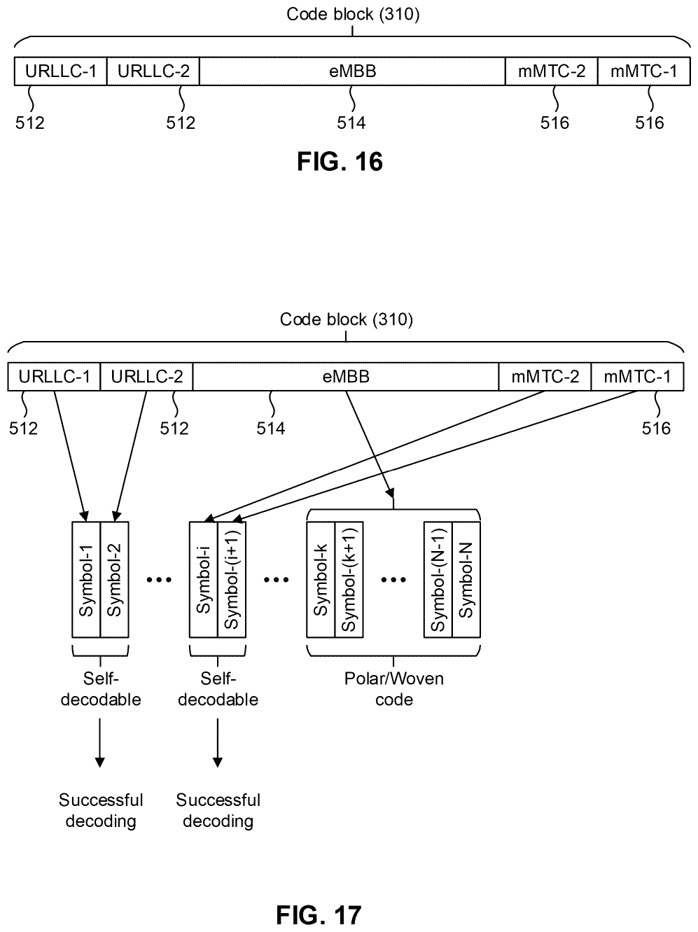

As shown in FIG. 16, the robot arm 500 uses the mixed-traffic coding method 400 to generate a joint code block 310 of a plurality of symbols or bits comprising a plurality of packets corresponding to the URLLC, eMBB, and mMTC messages. The URLLC packets 512, eMBB packets 514, and mMTC packets 516 are self-decodable. For example, the eMBB packets 514 may be codewords encoded using polar code or woven code. In this example, URLLC packets 512 are placed at the beginning of the code block 310, followed by eMBB packets 514, and then mMTC packets 516. As will be described below, such an order of the packets provides augmented eMBB coding with lowered error probability.

As shown in FIG. 17, the decoder first attempts to decode the short packets such as URLLC packets 512. If the URLLC packet 512 can be successfully decoded, the URLLC information bits coupled or otherwise included in the eMBB packets may augment the decoding of eMBB packet 514. The decoder may choose either to decode the eMBB packet 514, or the mMTC packets 516 next. If the eMBB packet 514 is decoded next and is successfully decoded, then the mMTC packets 516 may be decoded with lowered error probability; otherwise, if the mMTC packets 516 are decoded next and are successfully decoded, then the eMBB packet 514 may be decoded with even lower error probability.

Generally, the augmented decoding of a second packet after the successful decoding of a first packet is due to the coupling of information bits or coded bits between the two packets. In the case of coupled information bits, compared to a packet without the coupled information bits, the second packet will have fewer information bits to be decoded but its packet length remains the same, which means lower code rate. In the case of coupled coded bits, the second packet will have shortened code bits which are pre-known to the decoder, which also means lower code rate. In both cases, the code rate of at least one self-decodable codeword (such as eMBB) can be reduced, therefore resulting in an improved performance.

In these embodiments, if a first self-decodable packet (such as a URLLC packet) fails to decode, instead of requesting a retransmission, the receiver proceeds to decode a second (such as the next) self-decodable packet (for example, an eMBB packet). If the second self-decodable codeword is successfully decoded, the code rate of the first packet can be reduced and the second packet may be decoded, resulting in an improved performance.

Generally, if a self-decodable packet fails to decode, the receiver may further proceed to decode the next self-decodable packet. If the next self-decodable codeword fails to decode, the receiver may proceed to decode the further next packet until a self-decodable codeword is successfully decoded. Then, the receiver may come back to decode the immediate previous packet and subsequently all previous packets that were failed to decode.

If eventually, one or more packets fail to decode, the receiver may send a HARQ to the transmitter requesting for retransmission (described in more detail later).

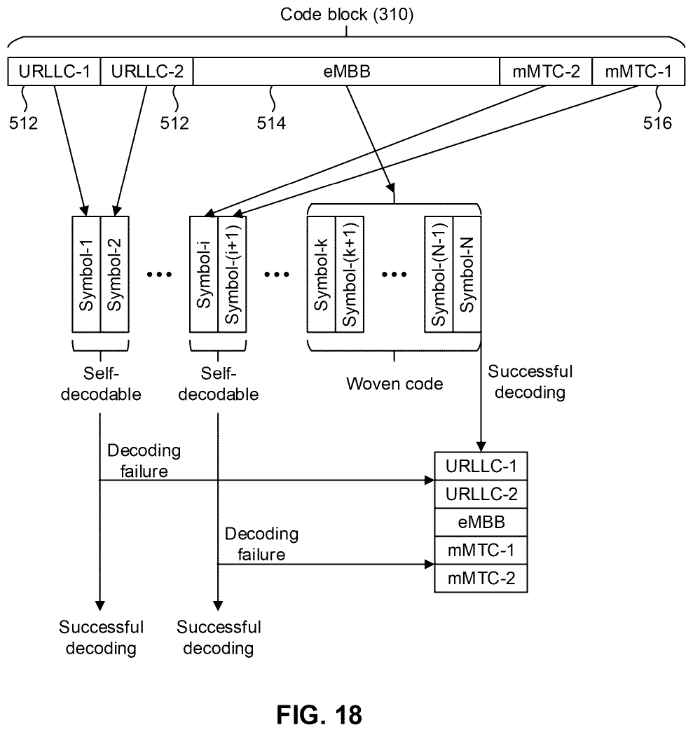

As shown in FIG. 18, in some embodiments, if a self-decodable packet (such as a URLLC packet) fails to decode, instead of immediately requesting a retransmission, the receiver proceeds to jointly decode the entire code block consisting of all packets. If the joint code word is successfully decoded, all messages (such as the URLLC, eMBB and mMTC messages 512 to 516 shown in FIG. 18) can be correctly recovered.

There are also two modes for coupling between URLLC symbols and eMBB symbols. The first is called tight coupling, where the coupling is within one slot or code block. The second is called loose coupling, where the coupling is between two consecutive slots or code blocks.

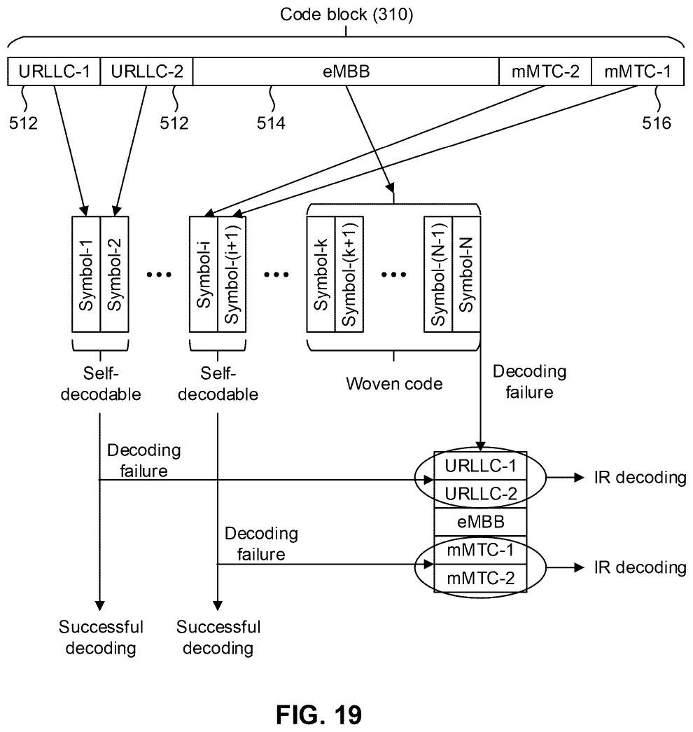

As shown in FIG. 19, in some embodiments, if eventually, one or more packets fail to decode, the receiver may request retransmission using incremental redundancy (IR) HARQ. More specifically, the retransmission contains the incremental code bits for the first message (such as the URLLC message 512), because a successful decoding of the first message will increase the chance of successful decoding for the subsequent messages. Optionally the retransmission may contain incremental code bits for the subsequent messages too, in order to further enhance decoding performance.

After receiving the retransmitted bits/symbols, the receiver will perform similar decoding attempts as mentioned above.

Conventionally, for UL transmission, when a UE 114 has messages to transmit (for example, messages arrived at the physical layer from a higher layer), if there is no resource already configured or scheduled for the UE 114, the UE 114 may send a scheduling request (SR) to the TRP 102 requesting for scheduling UL resource.

In NR, SR may contain some information of the traffic type through the SR resource configuration, which includes a scheduling request ID (which is associated with a logical channel, priority, and other information defined for the logical channel).

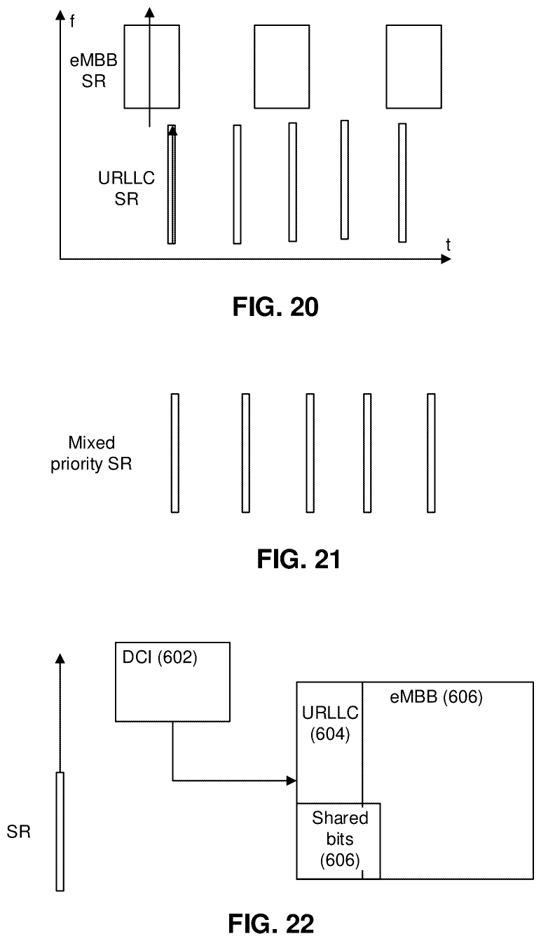

In some embodiments as shown in FIG. 20, if the UE 114 has messages of multiple traffic types to transmit, and there is no scheduled or configured resource for the transmissions thereof, the UE 114 can separately send multiple SRs to the TRP 102. Each separate SR corresponds to a traffic type to request the TRP 102 to schedule transmission of the message of the specific traffic type.

In some embodiments as shown in FIG. 21, a more efficient SR process may be used wherein the UE 114 may send to the TRP 102 a SR that indicates multiple traffic types associated therewith (denoted a “mixed-traffic SR”). In response, the TRP 102 schedules a mixed-traffic transmission in a single transport block (TB) or in separate TBs.

More specifically, in some embodiments, the SR resource is associated with a plurality of logical channels, by, for example, including a plurality of scheduling request IDs in the SR resource configuration, each scheduling request ID corresponding to a logical channel.

An example of RRC signaling for such a schedule-request configuration may be

```
  SchedulingRequestConfig
  SchedulingRequestToAddMod ::= SEQUENCE {
  schedulingRequestId1 SchedulingRequestId,
schedulingRequestId2 SchedulingRequestId2,
  ...}
```

wherein schedulingRequestId is used to modify a SR configuration, and to indicate (in LogicalChannelConfig, which is a data structure for configuring the logical channel parameters) the SR configuration to which a logical channel is mapped, and to indicate (in SchedulingRequestresourceConfig, which is a data structure for configuring the scheduling requester source) the SR configuration for which a scheduling request resource is used.

In the configuration of corresponding logic channel configuration (for example, LogicalChannelConfig field in RRC), the associated scheduling request ID may be included.

Thus, the UE 14 may send to the TRP 102 a mixed-traffic SR indicating multiple traffic types, or may send to the TRP 102 a plurality of conventional SRs each for a traffic type. The TRP 102 receives the mixed-traffic SR or the plurality of conventional SRs, and understands that the UE 114 needs to transmit messages of multiple traffic types. In response, the TRP 102 may schedule a mixed-traffic transmission (which jointly encodes the multiple traffic data and may be referred to as “mixed-traffic coding”) in a single TB or in separate TBs.

As shown in FIG. 22, the TRP 102 may send a DCI 602 to schedule multiple-traffic data transmission in one transmission, for example, in one TB transmitted in a PUSCH. For simplicity, in the example shown in FIG. 22, two traffic types are used with one being URLLC and the other being eMBB. Those skilled in the art understand that the method described herein can be used for other traffic types, and can be used for joint encoding of more than two traffic types.

The DCI 602 for scheduling a mixed-traffic data transmission (which may use the above-described mixed-traffic coding) may include the following five fields in order to provide necessary information for UE 114 to perform mixed-traffic coding:
a one-bit field to indicate to the UE 114 whether or not to perform mixed-traffic coding. This field may be optional in some embodiments wherein the UE 114 determines whether or not to perform mixed-traffic coding based on DCI format or radio network temporary identifier (RNTI).
a list indicating the traffic types for indicating which traffic data are used for joint encoding for each traffic type, wherein the list in these embodiments may comprise a plurality of traffic types and their corresponding information such as the corresponding services and priority indices. For example, in the case of mixed traffic encoding for two traffics, two of the traffic types or service types or priority indices are indicated. The traffic types may be listed in a fixed order (such as from the lowest priority to the highest priority, or from the highest priority to the lowest priority). In some embodiments, the list may not explicitly comprise the traffic types. Rather, the list may comprise a plurality of priority indices each indicating a priority level associated with a respective traffic type or logical channel. In some embodiments, the list may comprise a plurality of logical channel IDs or logical channel group IDs each associated with a respective traffic type. Note that logical channel ID is merely one example of association of the message (or data) with its priority, traffic type, or QoS. In some embodiments, the list may comprise a list of QoS values each associated with a respective traffic type, or a list of priorities, the priorities can be physical layer or priorities that are used for other layers instead of or in addition to the logical channels. For example, 5G QoS has been defined in higher layer (such as the application layer), which may be associated with the list of priorities or service indices.
coupling ratio: The coupling ratio indicates the ratio of shared payload of the high-priority traffic. For example, if there are two traffics of URLLC and eMBB traffic for mixed-traffic coding, the URLLC traffic or message may be encoded using a small code (same as the conventional coding), and then a portion of the URLLC payload is combined with the eMBB payload and jointly encoded using the large code. Then, the coupling ratio is the ratio of the shared payload over the URLLC payload. In other words, referring to FIGS. 12 and 14, the coupling ratio of the i-th message (i=1, 2, . . . , n−1) is Rᵢ=Mᵢ/Kᵢ. The DCI 602 may comprise an indication of the coupling ratio for each traffic type. In some embodiments, the mix-traffic method uses a predefined or preconfigured or otherwise default coupling ratio for all messages of a specific type. For example, if all the URLLC payload is always embedded into eMBB payload for joint encoding, the coupling ratio is default to 1 or 100%. In these embodiments, the default coupling may not need to be signaled in DCI. In other words, the DCI may not comprise an indication for indicating the coupling ratio of this specific traffic type. In some other scenarios, the coupling ratio as indicated may not be the ratio of the shared payload over the URLLC payload. Rather, it may be the ratio of the shared payload over eMBB payload, or the ratio of the shared payload over the combined payload used for joint encoding. In general, DCI may include an indication to calculate the number of bits from the small message used for joint encoding. It may not necessarily in the form of coupling ratio. For example, the number of bits of the shared bits can be directly indicated or indicated through other ratios.
resource ratio, which indicates the ratio of resource mapped for each traffic type over the total resource used for the TB. For example, when k traffic types are used, (k−1) resource ratios may be used to explicitly indicate the resources for (k−1) traffic types and the resource for k-th traffic type is implicitly indicated (because the total amount of resources are known (for example, usually indicated in the DCI) and all other resources are explicitly indicated by the respective resource ratios). In various embodiments, the resource ratios may be ratios of any suitable resource types. For example, in some embodiments, as the URLLC traffic may occupy a number of symbols in the beginning of the assigned resources, the resource ratio may be indicated implicitly by indicating the number or amount of symbols used for the higher-priority traffic type (such as URLLC). In some other embodiments, the resource ratio may indicate the amount of PRBs for a traffic type, such as the URLLC service, over the total amount of PRBs.
MCS for each traffic type, which is the target MCS for each traffic type such that messages of various traffic types may share the same modulation, and/or may use same or different MCS tables for each traffic type.

Tables 1 and 2 below show the examples of DCI indication for mixed traffic coding for two traffic type and three traffic type, respectively.

TABLE 1
EXAMPLES OF DCI INDICATION FOR MIXED
TRAFFIC CODING FOR TWO TRAFFIC TYPES

| Service | Traffic/priority/logical | Resource | | Coupling |
|---|---|---|---|---|
| index | channel index list | ratio (RR) | MCS | ratio |
| 1 | 0 | RR(1) | MCS(1) | 30% |
| 2 | 1 | N/A | MCS(2) | N/A |

TABLE 2
EXAMPLES OF DCI INDICATION FOR MIXED TRAFFIC
CODING FOR THREE TRAFFIC TYPES

| Service | Traffic/priority/logical | Resource | | Coupling |
|---|---|---|---|---|
| index | channel index list | ratio (RR) | MCS | ratio |
| 1 | 0 | RR(1) | MCS(1) | 30% |
| 2 | 2 | RR(2) | MCS(2) | 50% |
| 3 | 3 | N/A | MCS(.) | N/A |

The UE 114 determines the modulation and target coding rate based on the MCSs indicated in the DCI 602. In some embodiments, MCSs for different traffic types are independently indicated. They may share the same MCS Table, which provides the mapping from indicated MCS index to the modulation and target code rate it corresponds thereto. In some embodiments, a plurality of MCS tables may be used with each MCS table corresponding to a respective traffic type. For example, URLLC service may have a corresponding MCS table and eMBB may have another MCS table corresponding thereto. With the use of a MCS table, DCI 602 usually indicates an MCS index in the MCS table, which corresponds to a specific modulation order and target code rate. Table 3 shows an example of a MCS table (reproduced from Table 6.1.4.1-1, section 6.1.4.1, “3GPP TS 38.214 version 16.2.0 Release 16”, which is one of the MCS table used for PUSCH transmission in NR).

TABLE 3
MCS INDEX TABLE FOR PUSCH WITH
TRANSFORM PRECODING AND 64QAM

| MCS | Modulation | Target | |
|---|---|---|---|
| Index | Order | code Rate | Spectral |
| I_{MCS} | Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | Reserved |
| 29 | 2 | Reserved |
| 30 | 4 | Reserved |
| 31 | 6 | Reserved |

In some embodiments, multiple traffic types may share the same modulation scheme but different code rate. In these embodiments, there may be a shared indication of modulation scheme, and separate indication of each code rate. Alternatively, one of the traffic types may be indicated with an MCS index which corresponds to a modulation and target code rate based on an MCS table. Such an indicated MCS index is used for other traffic types to determine the modulation scheme, and therefore, the indication for other traffic types may only comprise a target code rate without an MCS index.

The determination of the transport block size (TBS) and payload size is now described.

Conventionally, the TB contains a single type of traffic data, and the TBS can be determined based on total available resources (for example, total available resource elements) calculated from the scheduled time/frequency/spatial resources (for example, MIMO layers, amount of resource blocks, amount of symbols, and/or the like). Using total amount of available resources (for example, amount of resources elements) together with the target code rate, the amount of payload or information bits that can be transmitted in the assigned resource can be calculated.

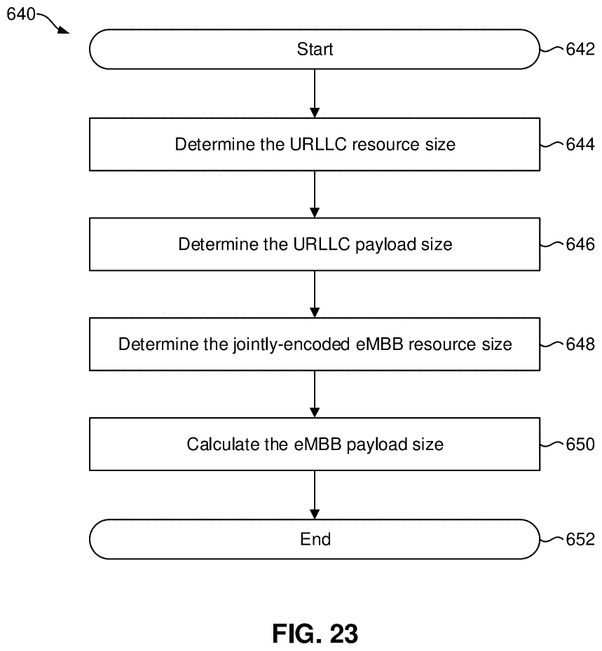

FIG. 23 is a flowchart showing the steps of a procedure 640 performed by a device such as a UE 114 for determining the payload sizes for different traffic types, according to some embodiments of this disclosure. For ease of description, two exemplary traffic types, URLLC and eMBB, are used, wherein the URLLC message will be encoded to a short code, and a portion of URLLC message is embedded in or combined with the eMBB message for encoding to a large code.

After the procedure 640 starts (step 642), the device determines the resource size used for URLLC (that is, the amount of resources assigned to URLLC) in terms of, for example, the amount of modulated symbols (which comprises URLLC coded bits) (step 644).

At this step, the amount of resources assigned to URLLC may be obtained from the resource ratio times the total amount of scheduled resource available for transmitting the URLLC message (denoted “total amount of available resource”, or “total available resource”), that is:

$$Resource for URLLC = Total available resource \times Resource ratio . \qquad ( 1 )$$

At step 646, the device determines the URLLC payload size.

At this step, the device first determines the amount of coded bits for URLLC based on the resource for URLLC and the target MCS indicated for URLLC (step 646), which is similar to the conventional TBS determination of a single traffic type. In other words, when the amount of resources (for example, the total amount of resource elements (REs)) for URLLC is known, one can determine the amount of modulated symbols M for URLLC that the resources can transmit. The amount of coded bits for URLLC is calculated as the amount of modulated symbols M times the amount of bits per symbol n based on the modulation scheme. For example, for 16-QAM, the amount of bits per symbol is n=log₂(16)=4 bits, and the amount of coded bits is 4M bits.

After obtaining the amount of coded bits for URLLC and with a known target code rate, the URLLC payload size such as the amount of information bits of URLLC message is calculated. Note that, as each of the numbers used in the calculation has to be an integer and limited granularity of target code rate can be indicated, approximations may be needed in the calculation. That is why the indicated code rate is a target code rate, and the actual code rate after obtaining the TBS may be slightly different but close to the target code rate.

At step 648, the device determines the jointly-encoded eMBB resource size in terms of, for example, the amount of jointly-encoded eMBB symbols (each encoding a portion of the URLLC bits and the eMBB bits), which may be calculated as the total amount of available resource minus the resource for URLLC, that is,

$$Resource for jointly - encoded eMBB = Total available resource - Resource for URLLC . \qquad ( 2 )$$

At step 650, the device determines the eMBB payload size.

At this step, the device first determines the amount of coded bits for jointly-encoded eMBB based on the resource for jointly-encoded eMBB and the target MCS indicated for jointly-encoded eMBB, which is similar to the conventional TBS determination of a single traffic type. In other words, when the amount of resources (for example, the total amount of resource elements (REs)) for jointly-encoded eMBB is known, one can determine the amount of modulated symbols for jointly-encoded eMBB that the resources can transmit. Typically, each available resource element of a spatial layer can be used to transmit one modulated symbol. The amount of coded bits for jointly-encoded eMBB is calculated as the amount of modulated symbols times the amount of bits per symbol based on the modulation scheme.

Then, the amount of combined information bits is calculated based on the amount of coded bits for jointly-encoded eMBB and a known target code rate. Note that the combined information bits comprise the shared bits of URLLC and the bits of eMBB. Thus, at this step, the amount of information bits of eMBB message is:

$$Amount of information bits of eMBB = Amount of combined information bits - Amount of shared bits of URLLC , \qquad ( 3 )$$

$$where$$

$$Amount of shared bits of URLLC = Amount of information bits of URLLC \times Coupling ratio . \qquad ( 4 )$$

The procedure 640 is ended (step 652).

As those skilled in the art understand, in many wireless communications systems such as 5G NR and similar systems, the assigned resource is not fully available for transmitting information symbols as a portion of the assigned resource may be used for other purposes such as for transmitting reference symbols (RSs) and/or for necessary overhead. Therefore, at steps 644 and 646, the UE 114 needs to determine the available resource in order to determine the URLLC and eMBB payload size.

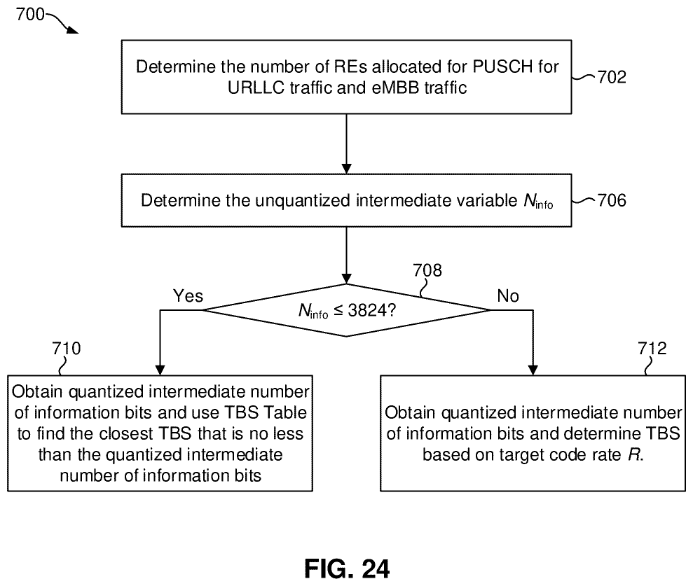

FIG. 24 shows an example 700, wherein the specification and parameters described in the current NR standard ([3GPP TS 38.214]) are modified as an example that is used to determine the TBSs for URLLC and eMBB.

At step 702, the UE 114 determines the number or amount of REs within the slot.

At this step, the UE 114 first determines the amount of

$$REs ( {N}_{{RE}_{URLLC}}^{′} )$$

allocate for PUSCH for URLLC traffic within a PRB and the amount of

$$REs ( {N}_{{RE}_{eMBB}}^{′} )$$

allocated for PUSCH for eMBB traffic within a PRB.

In some embodiments wherein the resource ratio is indicated as a number of symbols used for URLLC, the UE 114 determines the amount of

$$REs ( {N}_{{RE}_{URLLC}}^{′} )$$

allocated for PUSCH for URLLC traffic within a PRB as:

$${N}_{R {E}_{URLLC}}^{′} = {N}_{sc}^{RB} \cdot {N}_{URLLC}^{sh} - {N}_{DMRS}^{PRB} - {N}_{oh}^{PRB} , \qquad ( 5 )$$

where:

$${N}_{sc}^{RB} = 12$$

is the amount of subcarriers in the frequency domain in a physical resource block,

$${N}_{DMRS}^{PRB}$$

is the amount of REs tor DM-RS per PRB in the allocated duration including the overhead of the DM-RS CDM groups without data, as described for PUSCH with a configured grant in Clause 6.1.2.3 of [3GPP TS 38.214], or as indicated by DCI format 0_1 or DCI format 0_2 or as described for DCI format 0_0 in Clause 6.2.2 [3GPP TS 38.214],

$${N}_{oh}^{PRB}$$

is the overhead configured by higher layer parameter xOverhead in PUSCH-ServingCellConfig, and

$${N}_{URLLC}^{sh}$$

is the number of symbols used for URLLC which is calculated using Equation (1) as the total number of symbols L_{Symbol} of the PUSCH allocation times the resource ratio, that is,

$${N}_{URLLC}^{sh} = {L}_{Symbol} \cdot Resource ratio . \qquad ( 6 )$$

In above calculation, the resource ratio is used for determining a fraction of symbols. Moreover, if the

$${N}_{oh}^{PRB}$$

is not configured (for example, not configured to have a value of 6, 12, or 18), then

$${N}_{oh}^{PRB}$$

is set to zero (0). In case or PUSCH repetition Type B,

$${N}_{DMRS}^{PRB}$$

is determined assuming a nominal repetition with the duration of L symbols without segmentation.

Similarly, the amount of

$$REs ( {N}_{{RE}_{eMBB}}^{′} )$$

allocated for PUSCH for eMBB traffic within a PRB is calculated as:

$${N}_{R {E}_{eMBB}}^{′} = {N}_{sc}^{RB} \cdot {N}_{eMBB}^{sh} - {N}_{DMRS}^{PRB} - {N}_{oh}^{PRB} , \qquad ( 7 )$$

where

$${N}_{eMBB}^{sh}$$

is the number or amount of symbols used for eMBB which is calculated using Equation (2) as the total number of symbols L_{Symbol} of the PUSCH allocation minus the number of symbols

$${N}_{URLLC}^{sh}$$

used for URLLC, that is,

$${N}_{eMBB}^{s h} = {L}_{S y mbol} - {N}_{URLLC}^{sh} . \qquad ( 8 )$$

In this example, Equations (6) and (8) are used in some scenarios wherein the URLLC and eMBB resources share the same amount of PRBs in frequency domain but use different symbols, the resource ratio is indicated as a ratio of number of symbols used for URLLC over total number of symbols. In some other scenarios where URLLC and eMBB are occupying different PRBs in frequency domain but use the same number of symbols,

$${N}_{URLLC}^{sh} and {N}_{eMBB}^{sh}$$

may be both given by the same L symbols without multiplying the resource ratio.

After calculating

$${N}_{R {E}_{URLLC}}^{′} and {N}_{{RE}_{eMBB}}^{′} ,$$

the UE 114 then determines the number of REs (N_{RE}_{_{URLLC}}) allocated for PUSCH for URLLC traffic and the number of REs (N_{RE}_{_{eMBB}}) allocated for PUSCH for eMBB traffic.

The total number of Res (N_{RE}_{_{URLLC}}) allocated for PUSCH for URLLC traffic is calculated as:

$${N}_{{RE}_{URLLC}} = N \cdot min ( 156 , {N}_{{RE}_{URLLC}}^{′} ) \cdot {n}_{PRB} , \qquad ( 9 )$$

where n_{PRB} is the total number of allocated PRBs for the UE 114, N≥1 is the number of slots used for TBS determination, which may be indicated by numberOfSlotsTBoMS. N=1 represents the case where only a single slot is used for scheduling PUSCH.

The total number of Res (N_{RE}_{_{eMBB}}) allocated for PUSCH for eMBB traffic is calculated as:

$${N}_{{RE}_{eMBB}} = N \cdot min ( 1 \; 56 , {N}_{{RE}_{eMBB}}^{′} ) \cdot {n}_{PRB} , \qquad ( 10 )$$

In some embodiments wherein the resource ratio is indicated as a number of symbols used for URLLC, the UE 114 determines the amount of

$$Res ( {N}_{RE}^{′} )$$

allocated for PUSCH within a PRB by:

$${N}_{RE}^{′} = {N}_{sc}^{RB} \cdot {N}_{symb}^{sh} - {N}_{DMRS}^{PRB} - {N}_{oh}^{PRB} , \qquad ( 11 )$$

Then, the total amount of Res (N_{RE}_{_{URLLC}}) allocated for PUSCH for URLLC traffic is calculated as:

$${N}_{{RE}_{URLLC}} = N \cdot min ( 1 \; 56 , {N}_{RE}^{′} ) \cdot {n}_{{PRB}_{URLLC}} , \qquad ( 12 )$$

where n_{PRB}_{_{URLLC}} is the number of PRBs allocated for URLLC which is calculated using Equation (1) as the allocated PRBs L_{PRB} times the resource ratio, that is,

$${n}_{{PRB}_{URLLC}} = {L}_{PRB} \cdot Resource ratio . \qquad ( 13 )$$

Note that there may be a further rounding process to round n_{PRB}_{_{URLLC}} to an integer, that is, to get an integer number of PRBs for URLLC. In this example, the resource ratio is used for determining a fraction of PRBs.

Similarly, the total amount of Res (N_{RE}_{_{eMBB}}) allocated for PUSCH for eMBB traffic is calculated as:

$${N}_{{RE}_{eMBB}} = N \cdot min ( 156 , {N}_{{RE}_{eMBB}}^{′} ) \cdot {n}_{{PRB}_{eMBB}} , \qquad ( 14 )$$

where n_{PRB}_{_{eMBB}} is the number of PRBs allocated for eMBB which is calculated using Equation (2) as the total number of allocated PRBs L_{PRB} minus the number of PRBS N_{RE}_{_{URLLC}} allocated for URLLC, that is,

$${n}_{{PRB}_{eMBB}} = {L}_{PRB} - {n}_{{PRB}_{URLLC}} . \qquad ( 15 )$$

In this example, Equations (13) and (15) are used in some scenarios wherein the URLLC and eMBB resources use the same symbols in time domain but use different PRBs in frequency domain, and the resource ratio is indicated as a ratio of number of PRBs used for URLLC over total number of PRBs. In some other scenarios wherein URLLC and eMBB use the same PRBs in frequency domain but use the different symbols, n_{PRB}_{_{eMBB}} and N_{PRB}_{_{URLLC}} may be both given by the same L_{PRB} without multiplying the resource ratio. In general, the total number of REs available for URLLC may be proportional to the resource ratio.

The subsequent steps 706 to 712 are the same for URLLC and eMBB. Therefore, for ease of description, the following description of steps 706 to 712 does not explicitly refer to URLLC or eMBB. However, those skilled in the art will understand that the parameters mentioned below are specific to URLLC (when calculating TBS for URLLC) or eMBB (when calculating TBS for eMBB). For example, N_{RE} described below shall refer to N_{RE}_{_{URLLC}} when calculating TBS for URLLC, or shall refer to N_{RE}_{_{eMBB}} when calculating TBS for eMBB.

At step 706, the UE 114 determines the unquantized intermediate variable (N_{info}) as:

$${N}_{info} = {N}_{RE} \cdot R \cdot {Q}_{m} \cdot v , \qquad ( 16 )$$

where R is the target code rate, Qₘ is the modulation order (that is, the number of bits per modulated symbol), and v is the number of layers (or MIMO layers) for the transmission. In these embodiments, R and Qₘ are indicated in the MCS index in DCI and obtained from mapping the MCS index in the MCS table. In this equation, N_{RE} is the number of resource elements available, which can be interpreted as the number of modulation symbols that can be transmitted per layer. Thus, N_{RE}·R·Qₘ·υ can be interpreted as the number of coded bits that can be transmitted in the available resource. The number of coded bits multiplying the code rate R is the number of information bits that can be transmitted.

At step 708, the UE 114 check if N_{info}≤3824. If N_{info}≤3824, the procedure goes to step 710 and the UE 114 obtains quantized intermediate number of information bits

$${N}_{info}^{′}$$

as:

$${N}_{info}^{′} = max ( 24 , {2}^{n} \cdot ⌊ \frac{{N}_{info}}{{2}^{n}} ⌋ ) \qquad ( 17 )$$

where n=max(3, └log₂(N_{info})┘−6) and └x┘ rounds x to the largest integer than is smaller than or equal to x.

Then, the UE 114 uses a TBS table, such as Table 5.1.3.2-1 in 3GPP TS 38.214 version 16.2.0 Release 16 (reproduced as Table 4 below), to find the closest TBS that is no less than

$${N}_{info}^{′} ,$$

and the procedure goes to step 648.

TABLE 4
TBS FOR N_{info} ≤ 3824

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

If at step 708, it is determined that N_{info}>3824, then the procedure goes to step 712 and the UE 114 obtains quantized intermediate number of information bits

$${N}_{info}^{′}$$

as:

$${N}_{info}^{′} = max ( 3840 , {2}^{n} \times round ( \frac{{N}_{info} - 24}{{2}^{n}} ) ) \qquad ( 18 )$$

where n=└log₂(N_{info}−24)┘−5 and ties in the round function are broken towards the next largest integer, └x┘ gives the greatest integer that is smaller than or equal to x, and the round function round (x) gives the nearest integer to x.

Then, the UE 114 determines the TBS based on the target code rate R. More specifically, the UE 114 checks if

$$R \leq \frac{1}{4} .$$

If

$$R \leq \frac{1}{4} ,$$

the TBS is calculated as:

$$TBS = 8 \cdot C \cdot ⌈ \frac{{N}_{info}^{′} + 24}{8 \cdot C} ⌉ - 24 , \qquad ( 19 )$$

where

$$C = ⌈ \frac{{N}_{info}^{′} + 24}{3816} ⌉ ,$$

and ┌x┐ gives the smallest integer than is greater than or equal to x.

If

$$R > \frac{1}{4} ,$$

the UE 114 further checks if

$${N}_{info}^{′} > 842 \; 4 .$$

If

$${N}_{info}^{′} > 8424 ,$$

the TBS is calculated as:

$$TBS = 8 \cdot C \cdot ⌈ \frac{{N}_{info}^{′} + 24}{8 \cdot C} ⌉ - 24 , \qquad ( 20 )$$

where

If

$$C = ⌈ \frac{{N}_{info}^{′} + 24}{8424} ⌉ .$$

If

$${N}_{info}^{′} \leq 8424 ,$$

the TBS is calculated as:

$$TBS = 8 \cdot ⌈ \frac{{N}_{info}^{′} + 24}{8} ⌉ - 24. \qquad ( 21 )$$

In some embodiments, the TRP 102 may not know the payload size of URLLC due to lack of buffer status report (BSR) information. In these embodiments, dynamic URLLC payload is used. In other words, the payload size for URLLC may be based on UE's buffer for URLLC traffic.

For example, in some embodiments, dynamic URLLC resource allocation may be used. In these embodiments, the TRP 102 may not indicate a resource ratio in the DCI or the resource ratio is not used. The UE 114 first determines the URLLC payload based on the indicated service ID (as described further below) which indicates the corresponding URLLC traffic (or logical channel). Then, the UE 114 checks its buffer with respect to the URLLC traffic (or logical channel) to determine the payload size for URLLC traffic (that is, how much URLLC data the UE 114 has). The UE 114 may determine the payload size to be equal to its buffer, or for example, in the case that the buffer size is too large, a maximum value that the resource can accommodate. For example, the payload size may be determined as

$$payload = min ( UE ’ s URLLC buffer , payload threshold ) , \qquad ( 22 )$$

where min(x, y) gives the minimum value between x and y, and the payload threshold may be determined based on the maximum available resources for URLLC.

Then, after determining the payload size for URLLC, the modulation order and code rate are determined based on the MCS index indicated in the DCI. The UE 114 then determines the amount of resources allocated for URLLC based on the payload size of URLLC as well as MCS used for URLLC. Once the URLLC resource is determined, the rest of the resources are used for eMBB. In this way, the resource used for URLLC is dynamically allocated based on the UE's buffer size, while the payload that can be accommodated for eMBB also varies based on the dynamically allocated remaining resources allocated for eMBB.

In some embodiments, dynamic URLLC code rate may be used. In these embodiments, the time-frequency resource allocated for URLLC may be fixed which may be determined based on the resource ratio and total amount of resources indicated/scheduled in the DCI (that is, not a dynamic URLLC resource allocation). However, the payload size is determined based on UE's URLLC buffer similar to the dynamic URLLC resource allocation method described above (see Equation (22)). The UE 114 determines modulation order based on the indicated MCS index. Once the UE 114 determines the payload size, the UE 114 performs rate matching based on available URLLC resources and payload size, which determines the actual code rate. Therefore, target code rate is either not indicated or not used by the UE 114.

In these embodiments, the TRP 102 may use any suitable method to indicate the traffic type. For example, the traffic-type indication (also called a “service ID”) may comprise a traffic type index, a priority index, a service index, a logical channel ID or logical channel IDs, or any other information associated with the traffic type, priority, service, or logical channel ID(s).

In some embodiments, the traffic-type indication may be associated with a single logical channel ID. However, the logical channel ID may be a long symbol with too many bits for DCI, thereby causing a high DCI overhead. Moreover, a single logical channel ID may also limit the MAC layer flexibility for logical channel resource mapping.

Therefore, in some embodiments, the traffic-type indication, for example, via a priority index, may comprise or may be associated with a group of logical channel IDs or a group of allowed logical channel IDs. In these embodiments, once the service ID is indicated, the corresponding logical channel IDs, or group of logical channel IDs or group of allowed logical channel IDs may be configured, for example, in RRC.

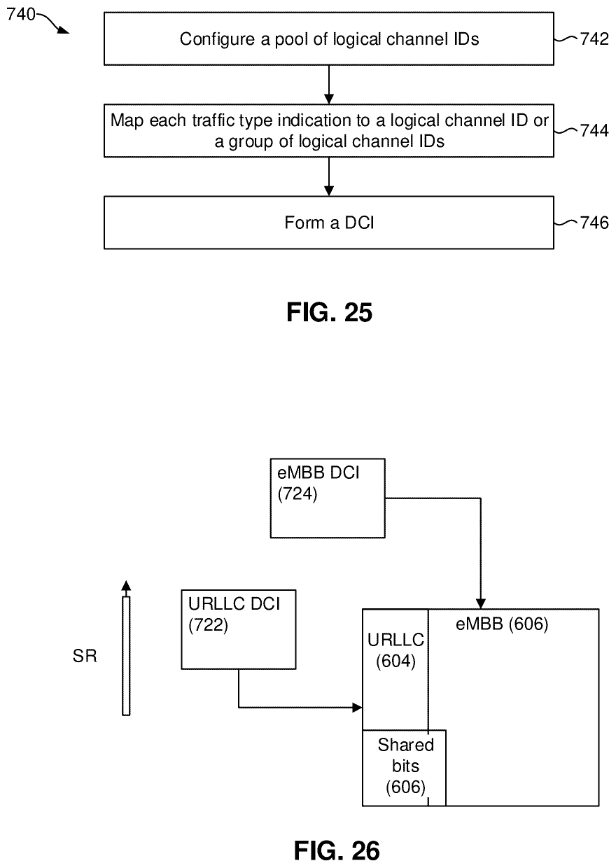

When the UE 114 selects the traffic data used for mixed traffic coding, the UE 114 may only select the traffic among the corresponding or allowed logical channels for mixed-traffic coding. FIG. 25 is a flowchart showing a procedure 740 for configuring the traffic-type indication.

At step 742, in RRC, a pool of logical channel (LC) IDs are configured for mixed-traffic coding. At step 744, each traffic type indication such as each service index is mapped to a logical channel ID or a group of logical channel IDs. At step 746, a DCI is formed which comprises the traffic-type indication. Of course, the traffic-type indication may alternatively be a traffic type index, a priority index, a service index, or other information associated with the traffic type, priority, service, or logical channel, as described above. Table 5 shows an example of the traffic-type indication in DCI and the associated group of logical channel IDs.

TABLE 5
Example of traffic-type indication in DCI and
the associated group of logical channel IDs

| DCI | MAC |
|---|---|
| Service/priority index/traffic | Logical |
| type/LC group index | channel IDs |
| 0 | 0, 1, 2 |
| 1 | 3, 4, 5, 6, 7 |
| 2 | 8, 9, 10, . . . |

In MAC layer, a logical channel ID among the mapped logical channel ID group is used for mapping the corresponding logical channel to payload of PHY layer for encoding. The selection of logical channel ID among the group of corresponding/allowed logical channel IDs are usually based on a priority rule, such as selecting the allowed logical channel with highest priority value.

Referring to FIG. 26, in some embodiments, the TRP 102 may schedule the mixed-traffic transmission by scheduling separate transmissions for different traffic types. Separate TBs may be used to transmit URLLC and eMBB traffics, wherein each traffic type (such as URLLC or eMBB) has its own TB and is scheduled by its own DCI wherein the time-frequency and other resources are separately scheduled for each traffic type. For example, two TBs may be scheduled separately for eMBB and URLLC transmissions (wherein each TB is a coupling TB of the other TB) while above-described joint mixed-traffic coding is still applied for the two traffic types. For example, in the eMBB transmission, some payload of URLLC is embedded into eMBB payload for joint coding in the eMBB transmission. In some other embodiments, the two traffics belonging to two different TBs may be scheduled by the same DCI with DCI content covering control information needed for both transmissions.

In these embodiments, the time-frequency resource is separately scheduled, and thus there is no need to indicate the resource ratio. As no eMBB information bits are embedded into URLLC (but there are some information bits of URLLC embedded into eMBB), then there is no additional information needed for scheduling URLLC transmission as the coding procedure is the same as if there is no mixed-traffic coding. However, for the eMBB scheduling DCI, additional information is needed to perform mixed-traffic coding by embedding a portion of the URLLC payload or URLLC coded bits into eMBB payload for joint encoding. Such additional information may include:
One (1) bit for informing or indicating to the UE 114 whether to perform mixed-traffic coding (which may be an indication for both eMBB and URLLC transmissions, or an indication only for the eMBB transmission where joint encoding is used).
Service index, priority index, and/or logical channel ID (or logical channel group ID) for the scheduled transmission (which may be different for the URLLC DCI and eMBB DCI). This indication can be any indication described in this disclosure for indicating a traffic type or for indicating an item of a traffic type (such as a priority, a quality-of-service value, a logical channel, a logical channel group, or the like), similar to what has been described for the mixed traffic transmission using as single TB example.
Coupling ratio or any other indication to indicate the amount of URLLC information bits to be embedded or coupled into the eMBB or joint transmission TB (which may be an indication for both eMBB and URLLC transmissions, or an indication only for the eMBB transmission where joint encoding is used). This indication is similar to the coupling ratio indication used for the mixed traffic transmission in single TB scenario.
Information to identify the other (coupling) TB or traffic used for joint encoding (which may be an indication for both eMBB and URLLC transmissions, or an indication only for the eMBB transmission where joint encoding is used).

In some embodiments, the coupling TB may be identified (thus indicated in the eMBB or joint transmission DCI) by:
HARQ process number (HPN);
A new UL multiplexing index (which may be similar to downlink assignment index (DAI));
A priority index, a service index, a traffic-type indication, or a logical channel index of the coupling TB.

For each TB, the HPN is usually indicated for the TB to allow asynchronous retransmission, where the UE 114 may identify which TB to retransmit based on the HPN. When the TRP 102 schedules a mixed-traffic coding through separate TBs, the TRP 102 may indicate, in the eMBB DCI, an additional HPN corresponding to the TB of URLLC transmission.

For example, in the URLLC transmission DCI, a HPN of zero (0) is indicated for the scheduled URLLC TB. In the eMBB DCI, a HPN of one (1) is indicated for the eMBB TB, with an additional DCI field indicating a HPN of zero (0) to identify the TB used for joint mixed-traffic coding. In other words, the HPN of zero (0) indicated in the additional DCI field refers to the scheduled URLLC traffic that is a part of the mixed-traffic coding with the eMBB. Therefore, the UE 114 knows which payload (that is, URLLC in this example) is used to joint encoding with the eMBB traffic.

In some embodiments, an UL multiplexing index is used for indicating an order of DCI transmission in time. The UE 114 may simply look for the UL multiplexing index that is prior to the current TB transmission for joint mixed-traffic coding. For example, in the DCI, each transmission may include an UL multiplexing index, which indicates the order of the DCI scheduled PUSCH transmission. In URLLC DCI, an UL multiplexing index of one (1) may be indicated. Then in eMBB DCI, an UL multiplexing index of two (2) is indicated, which means the eMBB PUSCH transmission or eMBB DCI transmission is after the corresponding URLLC transmission. If mixed-traffic coding is used, in the eMBB transmission, the UE 114 may find the previous UL multiplex index of one (1), which corresponds to the URLLC transmission. Then the corresponding URLLC data is used for mixed-traffic coding by jointly encoding it with the eMBB data in eMBB transmission. If the mixed traffic coding is applied to DL, then similarly a DL multiplexing index can be used.

In some embodiments wherein a priority index or a service index is used, in the eMBB DCI, in addition to its own priority index (such as one (1)) for its own eMBB traffic data, DCI also indicates a coupling priority index (such as zero (0)), which corresponds to the URLLC transmission. Therefore, the UE 114 knows to use the corresponding URLLC data for joint encoding with the eMBB data (by embedding a portion or all of the URLLC payload into eMBB encoding).

One or multiple of the above fields may be included in DCI. Table 6 below shows an example.

TABLE 6
EXAMPLE OF SOME FIELDS IN THE DCI

| Service | logical channel | | Coupling |
|---|---|---|---|
| index | ID/priority list | MCS | ratio |
| 1 | Own priority 1 | MCS(1) | 30% |
| 2 | Coupling priority 0 | | |

The above-described examples disclose methods, apparatuses, and systems for error-correction coding of mixed traffic types. In some examples, a TRP 102 may schedule mixed-traffic coding in a single TB, and a DCI to indicate priority index list and/or coupling ratio. As a result, an intra-UE mixed-traffic coding may improve the efficiency of the UE 114 in transmitting messages of multiple traffic types. Furthermore, the mixed-traffic coding method may also improve reliability of URLLC without dropping or negatively impacting eMBB traffic, which requires less retransmission. The logical channel index list allows the TRP 102 to control which traffic data to be used for joint channel coding.

In some examples, a TRP 102 may schedule mixed-traffic coding in multiple TBs, and a DCI to indicate coupling TB identification and/or coupling ratio. The coupling TB indication allows the UE 114 to identify shared payloads for encoding. In these examples, resources are clearly scheduled for different traffic types, yet fewer changes to the conventional DCI format are needed.

In some examples, a dynamic URLLC payload may be used, which allows the TRP 102 to allocate resource dynamically for URLLC without predefining URLLC payload in the scenario of lacking buffer information.

Although the above embodiments use uplink transmission over PUSCH as an example, the method disclosed herein may also be used in downlink data transmission over PDSCH in a similar manner. Moreover, the method disclosed herein may be further used in other data transmissions such as sidelink (SL) transmissions between UEs 114.

For DL mixed-traffic transmission, there is no SR to be transmitted, and data is transmitted from the TRP 102 to the UE 114. The TRP 102 may use a DCI to schedule a mixed-traffic coding transmission, wherein the DCI may comprise similar information as in uplink transmissions as described above. The TRP 102 may perform the mixed transmission encoding procedure in a similar manner as in the above-described uplink examples, and the UE 114 may obtain the encoding information from the DCI in a similar manner as described above, in order to decode the mixed-traffic codewords.

By integrating various services into a single FEC, with awareness of service priority (target block error rate (BLER), latency and sources), the mixed-traffic coding method disclosed herein enables both self decodability and enhanced joint decodability. In some examples, a joint decoding procedure may be used after a decoding failure, and a request for retransmission is used if the joint decoding procedure also fails to decode the mixed-traffic codewords.

According to some aspects of this disclosure, the methods, apparatuses, systems, and non-transitory computer-readable storage devices disclosed herein address the problem of efficiently encoding and transmitting different traffic types at the same UE 114.

According to some aspects of this disclosure, the methods, apparatuses, systems, and non-transitory computer-readable storage devices disclosed herein also relate to implementations for a TRP or base station 102 to inform the UE 114 to perform mixed-traffic coding.

According to some aspects of this disclosure, the methods, apparatuses, systems, and non-transitory computer-readable storage devices disclosed herein further relate to implementations for a UE 114 to identify which traffic data is used for the encoding process, and for a UE 114 to determine the resources and parameters used for mixed-traffic coding.

According to some aspects of this disclosure, the methods, apparatuses, systems, and non-transitory computer-readable storage devices disclosed herein may use mixed-traffic coding for transmitting multiple service types of the UE 114.

In some embodiments, a procedure for mixed-traffic coding to transmit multiple traffic types efficiently includes: a TRP 102 schedules a single TB transmission, where, in the single TB transmission, the UE 114 uses joint mixed-traffic coding to transmit higher priority data (such as URLLC) and lower priority data (such as eMBB) together.

The DCI to schedule the mixed-traffic transmission includes a list of traffic types and/or a priority index that is used for the mixed-traffic coding. The DCI may further include a resource ratio, MCS, a coupling ratio, and/or the like for at least one of the traffic types. The UE 114 performs joint mixed-traffic coding using the above-mentioned parameters.

According to some aspects of this disclosure, the methods, apparatuses, systems, and non-transitory computer-readable storage devices disclosed herein relate to a dynamic URLLC payload/resource assignment to, for example, allow a TRP 102 to maximize URLLC performance without BSR information.

According to some aspects of this disclosure, the methods, apparatuses, systems, and non-transitory computer-readable storage devices disclosed herein relate to a method that includes: a TRP 102 schedules a separate TB transmission for each of a plurality of traffic types with a joint mixed-traffic coding for encoding the messages of the plurality of traffic types. The DCI used to schedule one of the traffic types includes an identification of the other traffic type(s) used for the joint coding for the UE 114 to perform joint mixed-traffic coding.

The basic idea of a mixed traffic coding is to consider multiple services (at least two services) with different traffic types. The first traffic type (e.g. URLLC) may be protected by a small code (small code length) while the second traffic type (e.g. eMBB) may be protected by a larger code because of large payload. The main idea is to embed part or all of the information bits from the small code into the payload of the larger code and encode them together in the larger code. Decoding the small code can enhance the decoding of the larger code. While decoding of larger code can also improve the reliability of the small code if the small code cannot be independently decoded, which reduce the likelihood of retransmission for the small code.

Embodiments of the present disclosure add a new procedure between a decoding failure and the request for a retransmission. This is achieved by integrating various services into a single FEC, with awareness of service priority (target BLER, latency and sources). Meanwhile, a novel channel coding scheme enables both self decodability and enhanced joint decodability.

Embodiments of the present disclosure include the following main points to address the aforementioned problems.

Key point 1: a three-decoding-attempt transmission paradigm, where a new procedure called joint decoding is inserted between a decoding failure and a retransmission request.

1. (First decoding attempt) A receiver decodes the first payload after receiving the corresponding minimum required code bits (LLRs). If the decoding of the first payload is successful, it uses the correctly decoded bits to enhance the decoding performance of a second payload after the corresponding minimum required code bits are received.

2. (Second decoding attempt) If the decoding of the first payload fails, the receiver will not request a retransmission, but proceed to jointly decode with the second payload. After the decoding of the second payload (no matter success or failure), the joint decoding feature ensures that the first payload will be successfully decoded with a high probability.

3. (Third decoding attempt) If the decoding of the first payload still fails after the second decoding attempt, the receiver will request a retransmission from the transmitter. This will incur some delay, but the receiver will decode a third time with both the joint code word and the retransmitted code word.

Key point 2: a self-decodable joint coding design, such that each individual payload (for example, corresponding to a service) can be self-decoded, and at the same time support joint decoding to further enhance performance.

1. Embed several small messages into a longer code block;

2. Small messages are self-decodable, meaning they can be decoded after collecting a subset of the code bits (or symbols, LLRs); the subset of code bits is also a standalone short code;

3. Two or more small messages are jointly-decodable; the corresponding subsets of the code bits combine into a longer code. This is done through “coupling” between bits from the two messages. Specifically, all or a subset of the first message (here message means information bits, that is, bits before encoding) is copied and combined with the second message. The combined message is encoded into a second code word.

3-a. The bits from the first message can be directly copied and appended to the second message;

3-b. The bits from the first message can be transformed (for example, multiplying with a binary matrix) and appended to the second message.

Although in above embodiment information bit (message) coupling is used as an example, it is also feasible to use coded bits for coupling. In the case of systematic codes, message bits are also part of the code bits, and thus the two alternatives become the same.

In above description, the example shown in FIG. 15 is used to illustrate the mixed traffic coding methods.

Augmented eMBB coding: a joint code block comprises symbols/bits corresponding to URLLC, eMBB and mMTC packets. Each URLLC, eMBB, or mMTC packets are self-decodable. Typically, URLLC bits/symbols are placed in the beginning of the code block, followed by eMBB bits/symbols, and then mMTC bits/symbols.

The decoder first attempts to decode the short packets, e.g., URLLC. If the URLLC packet can be successfully decoded, its coupled bits in the eMBB packets can augment the decoding of eMBB. The decoder can choose either to decode the eMBB packet, or the mMTC packets next. If the eMBB packet is decoded next and is successfully decoded, then the mMTC packets can be decoded with lower error probability; otherwise if the mMTC packets are decoded next and are successfully decoded, then the eMBB packet can be decoded with even lower probability.

The augmented decoding of a second packet after the successful decoding of a first packet is due to the coupling of information bits or coded bits between the two packets. In the case of coupled information bits, the, the other packet will have fewer information bits but its packet length remains the same, which means lower code rate. In the case of coupled coded bits, the, the other packet will have shortened code bits which are pre-known to the decoder, which also means lower code rate. In both cases, the code rate of at least another self-decodable codeword (for example, eMBB) can be reduced, therefore resulting in an improved performance. See FIG. 17.

HARQ-less URLLC: One option is that if a self-decodable packet (for example, URLLC) fails to decode, instead of requesting a retransmission, the receiver proceeds to decode another self-decodable packet (for example, eMBB). If the latter self-decodable code word is successfully decoded, the code rate of the former can be reduced, resulting in an improved performance. The other option is that if a self-decodable packet (for example, URLLC) fails to decode, instead of requesting a retransmission, the receiver proceeds to jointly decode the entire code block consisting of URLLC, eMBB and mMTC. If the joint code word is successfully decoded, all the bits can be correctly recovered.

There are also two modes for coupling between URLLC symbols and eMBB symbols. The first is called tight coupling, where the coupling is within one slot or code block. The second is called loose coupling, where the coupling is between two consecutive slots or code blocks. See FIG. 18.

HARQ-less URLLC with IR combining: Only if the above second decoding attempts fails again, the receiver requests retransmission using incremental redundancy HARQ. Mandatorily, the retransmission must contain the incremental code bits for the first message (for example, URLLC), because a successful decoding of the first message will increase the chance of successful decoding for the subsequent messages. Optionally the retransmission may contain incremental code bits for the subsequent messages too, in order to further enhance decoding performance.

After receiving the retransmitted bits/symbols, the receiver will perform similar decoding attempts as mentioned above. See FIG. 19.

There are several possible ways to do self- and joint-coding. In fact, the packets can be coupled in a chain structure, or coupled in a star structure.

FIGS. 11 and 12 and related description presented above show the successive embedding.

FIGS. 13 and 14 and related description presented above show the multi-to-one embedding.

### Acronyms

| Acronym/Abbreviation/Initialism | Full Name |
|---|---|
| ACK | Acknowledgement |
| NACK | Non-Acknowledgement |
| BS | Base-Station |
| CB | Code Block |
| CR | Code Rate |
| CQI | Channel Quality Indicator |
| FEC | Forward Error Correction |
| HARQ | Hybrid Automatic Repeat Request |
| IR | Incremental redundancy |
| 2D HARQ | Two-Dimensional Hybrid |
| | Automatic Repeat Request |
| LDPC | Low Density Parity Check |
| LTE | Long-Term Evolution |
| NR | New Radio |
| Tx | Transmission |
| TB | Transport Block |
| UE | User Equipment |
| VCB | Vertical Code Block |
| CBG | Code Block Group |
| HPN | HARQ process number |
| DCI | Downlink control information |
| PDSCH | Physical downlink shared channel |
| NDI | New Data Indicator |
| PUCCH | Physical uplink control channel |
| SR | Scheduling request |
| LC | Logical Channel |
| MA | Multiple Access |
| QoS | Quality of Service |
| URLLC | ultra-reliable low |
| | latency communications |
| eMBB | Enhanced mobile broadband |
| mMTC | massive Machine Type |
| | Communications |
| MCS | Modulation Coding Scheme |
| PUSCH | Physical uplink shared channel |
| MIMO | Multiple input multiple output |

### Definitions of Some Terms

Herein, the term a “self-decodable” means that a codeword may be decoded without information of another codeword.

Herein, the term “predefined” (for example, a “predefined” item such as a “predefined” parameter) refers to an item defined before a certain even occurs or before a method is performed (for example, defined as a system design parameter, defined by relevant standards, and/or the like).

Herein, the term “preconfigured” (for example, a “preconfigured” item such as a “preconfigured” parameter) refers to an item configured (for example, by a TRP 102) before a certain even occurs or before a method is performed.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments of the mixed-traffic coding and transmission methods are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more TRPs 102), some other features may be implemented on the UE side, and/or yet some other features may be implemented on both the TRP side and the UE side. Depending on the functionalities of various features of the methods disclosed herein, some features may be implemented on the transmitting side (such as in one or more TRPs 102 and/or one or more UEs 114 for transmission), some other features may be implemented on the receiving side (such as in one or more TRPs 102 and/or one or more UEs 114 for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method comprising:
transmitting a downlink control information message specifying scheduling of an uplink or downlink transmission of a plurality of data pieces of a plurality of traffic types in a single data block via a communication resource, the plurality of traffic types comprising a first traffic type for transmission via a first portion of the communication resource and a second traffic type for transmission via a second portion of the communication resource; and
receiving or transmitting the plurality of data pieces in accordance with said scheduling specified in the downlink control information message.

2. The method of claim 1, wherein the downlink control information message comprises:
a first indication indicating the plurality of traffic types;
a second indication indicating an amount of the first portion of the communication resource used by the first traffic type;
a third indication indicating a modulation-and-coding scheme for each traffic type; or
a combination thereof.

3. The method of claim 2, wherein the second indication is a first ratio of the amount of the first portion of the communication resource used by the first traffic type of the plurality of traffic types over an amount of the communication resource.

4. The method of claim 2, wherein the first indication comprises a list having a plurality of items, each item corresponding to one of the plurality of traffic types; and
wherein each item comprises a traffic type of the plurality of traffic types, a priority, a quality-of-service value, a logical channel, or a logical channel group, and
wherein the second indication comprises a number of symbols for the data piece of the first traffic type, or a ratio of an amount of physical resource blocks of the first portion of the communication resource over an amount of physical resource blocks of the communication resource.

5. The method of claim 2, wherein a joint coding method is used for encoding at least a portion of the data piece of the first traffic type with the data piece of the second traffic type; and
wherein the downlink control information message further comprises a fourth indication indicating an amount of the at least portion of the data piece of the first traffic type.

6. A method comprising:
receiving a downlink control information message specifying scheduling of an uplink or downlink transmission of a plurality of data pieces of a plurality of traffic types in a single data block via a communication resource, the plurality of traffic types comprising a first traffic type for transmission via a first portion of the communication resource and a second traffic type for transmission via a second portion of the communication resource; and
receiving or transmitting the plurality of data pieces in accordance with said scheduling specified in the downlink control information message.

7. The method of claim 6, wherein the downlink control information message comprises:
a first indication indicating the plurality of traffic types;
a second indication indicating an amount of the first portion of the communication resource used by the first traffic type;
a third indication indicating a modulation-and-coding scheme for each traffic type; or
a combination thereof.

8. The method of claim 7, wherein the second indication is a first ratio of the amount of the first portion of the communication resource used by the first traffic type over an amount of the communication resource.

9. The method of claim 7, wherein the first indication comprises a list having a plurality of items, each item corresponding to one of the plurality of traffic types; and
wherein each item comprises a traffic type of the plurality of traffic types, a priority, a quality-of-service value, a logical channel, or a logical channel group, and
wherein the second indication comprises a number of symbols for the data piece of the first traffic type, or a ratio of an amount of physical resource blocks of the first portion of the communication resource over an amount of physical resource blocks of the communication resource.

10. The method of claim 7, wherein a joint coding method is used for encoding at least a portion of the data piece of the first traffic type with the data piece of the second traffic type; and
wherein the downlink control information message further comprises a fourth indication for indicating an amount of the at least portion of the data piece of the first traffic type.

11. An apparatus comprising:
at least one processor; and
a memory coupled to the at least one processor, the memory storing instructions that, when executed by the at least one processor, cause the apparatus to:
transmit a downlink control information message specifying scheduling of an uplink or downlink transmission of a plurality of data pieces of a plurality of traffic types in a single data block via a communication resource, the plurality of traffic types comprising a first traffic type for transmission via a first portion of the communication resource and a second traffic type for transmission via a second portion of the communication resource; and
receive or transmit the plurality of data pieces in accordance with said scheduling specified in the downlink control information message.

12. The apparatus of claim 11, wherein the downlink control information message comprises:
a first indication indicating the plurality of traffic types;
a second indication indicating an amount of the first portion of the communication resource used by the first traffic type;
a third indication indicating a modulation-and-coding scheme for each traffic type; or
a combination thereof.

13. The apparatus of claim 12, wherein the second indication is a first ratio of the amount of the first portion of the communication resource used by the first one of the plurality of traffic types over an amount of the communication resource.

14. The apparatus of claim 12, wherein the first indication comprises a list having a plurality of items, each item corresponding to one of the plurality of traffic types; and
wherein each item comprises a traffic type of the plurality of traffic types, a priority, a quality-of-service value, a logical channel, or a logical channel group, and
wherein the second indication comprises a number of symbols for the data piece of the first traffic type, or a ratio of an amount of physical resource blocks of the first portion of the communication resource over an amount of physical resource blocks of the communication resource.

15. The apparatus of claim 12, wherein a joint coding method is used for encoding at least a portion of the data piece of the first traffic type with the data piece of the second traffic type; and
wherein the downlink control information message further comprises a fourth indication for indicating an amount of the at least portion of the data piece of the first traffic type.

16. An apparatus comprising:
at least one processor; and
a memory coupled to the at least one processor, the memory storing instructions that, when executed by the at least one processor, cause the apparatus to:
receive a downlink control information message specifying scheduling of an uplink or downlink transmission of a plurality of data pieces of a plurality of traffic types in a single data block via a communication resource, the plurality of traffic types comprising a first traffic type for transmission via a first portion of the communication resource and a second traffic type for transmission via a second portion of the communication resource; and
receive or transmit the plurality of data pieces in accordance with said scheduling specified in the downlink control information message.

17. The apparatus of claim 16, wherein the downlink control information message comprises:
a first indication indicating the plurality of traffic types;
a second indication indicating an amount of the first portion of the communication resource used by the first traffic type;
a third indication indicating a modulation-and-coding scheme for each traffic type; or
a combination thereof.

18. The apparatus of claim 17, wherein the second indication is a first ratio of the amount of the first portion of the communication resource used by the first traffic type over an amount of the communication resource.

19. The apparatus of claim 17, wherein the first indication comprises a list having a plurality of items, each item corresponding to one of the plurality of traffic types; and
wherein each item comprises a traffic type of the plurality of traffic types, a priority, a quality-of-service value, a logical channel, or a logical channel group, and
wherein the second indication comprises a number of symbols for the data piece of the first traffic type, or a ratio of an amount of physical resource blocks of the first portion of the communication resource over an amount of physical resource blocks of the communication resource.

20. The apparatus of claim 17, wherein a joint coding method is used for encoding at least a portion of the data piece of the first traffic type with the data piece of the second traffic type; and
wherein the downlink control information message further comprises a fourth indication for indicating an amount of the at least portion of the data piece of the first traffic type.
